(19) United States
(12) Patent Application Publication
(10) Pub. No.: US 2008/0127686 A1
(43) Pub. Date: Jun. 5, 2008

(54) Door locking apparatus

(76) Inventor: Moon Sung Hwang, Seoul (KR)

Correspondence Address: Robert E. Bushnell, Suite 300, 1522 K Street, N.W., Washington, DC, 20005, US

(21) Appl. No.: 11/802,905

(22) Filed: May 25, 2007

(30) Foreign Application Priority Data
Nov. 30, 2006 (KR) 10-2006-0119564

(51) Int. Cl. E05B 59/00; G06K 7/00; G06K 9/00

(52) U.S. Cl. 70/107; 340/5.6; 382/124

(57) ABSTRACT

Disclosed is an electronic door locking apparatus having a mortise lock including dead bolt and latch bolt installed therein, which is able to easily open a door from the outside by inserting a metal card having a magnet installed inside if a power source such as a dry battery is not supplied or if the locking apparatus is not used due to other mechanical defects, and also able to perform a lock function since a dead bolt is locked if a handle grip of an outer unit is revolved upwards when there are defects in a driving motor or electronic components. For this purpose, the present invention provides a door locking apparatus including a mortise lock having a dead bolt extruded and contracted by a driving force of a motor installed in the inner unit in order to lock/unlock a door, and a door locking/unlocking latch bolt operated by the handle grips of the inner and outer units; a latch bolt driving means for operating the latch bolt; a dead bolt driving means for operating the dead bolt; an emergency release assembly installed inside the outer unit and engaged with the handle grip of the outer unit in order to unlock the locked dead bolt when it is turned off by means of the motor; and an emergency card inserted into the emergency release assembly to unlock the dead bolt.

### CLAIM OF PRIORITY

This application makes reference to, incorporates the same herein, and claims all benefits accruing under 35 U.S.C. §119 from an application earlier filed in the Korean Intellectual Property Office on Nov. 30, 2006 and there duly assigned Serial No. 10-2006-0119564.

### BACKGROUND OF THE INVENTION

1. Field of the Invention

The present invention relates to an electronic door locking apparatus having a mortise lock installed therein, the mortise lock including a dead bolt and a latch bolt, and more particularly to an electronic door locking apparatus including a keypad, a fingerprint recognition device and a card reader, which is able to easily open a door from the outside by inserting a metal card having a magnet installed inside if a power source such as a dry battery is not supplied or if the locking apparatus is not used due to other mechanical defects, and also able to perform a lock function since a dead bolt is locked if a handle grip of an outer unit is revolved upwards when there are defects in a driving motor or electronic components.

2. Description of the Prior Art

Locking apparatuses such as door locks may be divided into a mechanical apparatus, an electrical apparatus and an electronic apparatus, depending on their operation systems. Here, the mechanical apparatus is configured so that it can be manually locked and unlocked, the electrical apparatus is configured so that it can be automatically locked and unlocked using a solenoid, a motor, etc., and the electronic locking apparatus serves to determine locking and unlocking states using a keypad, a fingerprint recognition device, a card reader, etc. In the recent years, the electronic locking apparatus has been increasingly used due to its easy usage and reliable security.

Such an electronic locking apparatus is a system in which electronically performs the certification procedure of visitors, and the actual locking and unlocking of a locker corresponding to the mortise lock and the like is mechanically performed by the key locking apparatus. Accordingly, the key locking apparatus should be effectively operated sine it is organizedly connected to electronic parts (certification parts and a locker) when unlocking (or locking) the locking.

However, a variety of the door locking apparatuses using such a mortise lock do not satisfactorily play a role as the locking apparatus or is damaged due to its complex configuration and instability in its operation between components if it is used for an extended time.

Generally, most of the door locking apparatuses include a latch bolt for locking and unlocking a door while popping in or out using an operation mechanism provided with a rotation means such as handle grips which are each installed inside or outside the door.

In order to prevent the instability in locking the door using a latch bolt, the door locking apparatuses also include a dead bolt operating means bolt for locking and unlocking a door while popping a dead bolt in or out using an operation mechanism provided with a rotation means such as a rotation knob, or a key rotation means such as a card key reader module, regardless of the operation mechanism of the latch bolt.

There is a mortise lock having a dual locking system of a latch bolt and a dead bolt, which is widely used for such a door locking apparatus. For example, Korean Patent No. 399168 issued by this applicant discloses a door locking apparatus separately composed of a dead bolt and a latch bolt and having a function of automatically locking the dead volt (an auto re-lock dead bolt).

In the case of the door locking apparatus, a poor may be freely opened by users inside the door, while it may be opened from the outside only by authorized persons. Also, convenience of the users was accommodated since the user can open the door without requesting a help of the authorized persons inside the door by opening a door from the outside using a remote controller.

However, the door locking apparatus may be configured using electrical components such as solenoid so that the authorized person outside a door can open the door. That is to say, there is no choice but to depend on the components that be electrically operated, such as solenoid, so as to open the door from the outside if the door is opened by employing a user recognition system such as a RF card reader, and a remote controller.

Accordingly, the electrical components has a problem that the authorized user outside the door never opens the door without a help from a person inside the door when a power source is not supplied since the electrical components are operated only when they are connected to an internal power source or an external power source.

Also, if a handle grip of an outer unit includes a separate cylinder key, a door may be damaged by drilling outside the door when one forcibly opens the door, and therefore it is uneconomical since the entire door locking apparatus may be exchanged.

That is to say, the conventional electronic door locks are automatically opened using a password, a card and a fingerprint, and automatically locked when the door is closed, but it has a problem that it can not exhibit a crime prevention function since it functions as a locking apparatus while one is out because its dead bolt is not locked if a motor or electronic and mechanical parts are out of order.

Also, the door is automatically closed by means of electromotion of the motor while one is out, and the dead bolt is not interlocked by the keypad since the emergency such as a fire melts the electronic components, and therefore it is difficult to bring the fire under control.

### SUMMARY OF THE INVENTION

Accordingly, the present invention is designed to solve such drawbacks of the prior art, and therefore an object of the present invention is to provide an electronic door locking apparatus capable of easily opening a door from the outside by inserting a metal card, which has a magnet installed inside, into an emergency release assembly if a power source such as a dry battery is not supplied or when the locking apparatus is not used due to other mechanical defects.

Another object of the present invention is to provide a door locking apparatus capable of performing a lock function since a dead bolt is locked if a handle grip of an outer unit is revolved upwards when there are defects in a driving motor or electronic components.

Still another object of the present invention is to provide a door locking apparatus capable of performing a perfect crime prevention function since the door is automatically opened by means of the ord and card and the fingerprint and locked when the door is closed, but the door may be manually locked by turning a hand grip upwards in the worst case where there are defects in the electronic parts or the mechanical parts.

Yet another object of the present invention is to provide a door locking apparatus capable of ensuring safety in opening the door by employing a mechanical connection system regardless of automatically opening the door with a barium ferrite emergency card, other than a key, into which a magnetic data is inputted, regardless of the components burned or melted in the emergency such as a fire since the door is not opened by the electromotion but mechanically opened in a one-touch system by means of an operation of a lever along with the latch bolt and the dead bolt while one is out.

One embodiment of the present invention is achieved by providing a door locking apparatus having an inner unit having a handle grip and installed in one side of a door, and an outer unit installed in the other side of the door corresponding to the inner unit and having a handle grip, the door locking apparatus including a mortise lock having a dead bolt extruded and contracted by a driving force of a motor installed in the inner unit in order to lock/unlock a door, and a door locking/unlocking latch bolt operated by the handle grips of the inner and outer units; a latch bolt driving means for operating the latch bolt; a dead bolt driving means for operating the dead bolt; an emergency release assembly installed inside the outer unit and engaged with the handle grip of the outer unit in order to unlock the locked dead bolt when it is turned off by means of the motor; and an emergency card inserted into the emergency release assembly to unlock the dead bolt.

The mortise lock used in the present invention preferably opens/closes the latch bolt, wherein the mortise lock includes a latch driving slider having a groove slid when the handle grips of the inner and outer units is independently revolved and receiving a rotation lever, and a shoulder portion for driving a link member; a link member engaged with the latch driving slider to operate the latch bolt so as to open/close a door; an elastic member for supplying elasticity to the latch driving slider when operated by the link member; a drive plate connected with the latch bolt; and a pin fixed to the drive plate and associated with one end of the link member.

Also, the mortise lock preferably further includes a rotation lever having a hole into which a pivot of a plunger is inserted so that it is revolved together when revolving the motor installed in the inner unit, and a dead bolt transfer arm; a dead bolt drive plate for fixing a dead bolt in its one end and having guide slots, and a reception notch unit receiving the dead bolt transfer arm; and an elastic member for resiliently driving the dead bolt drive plate when operating the transfer arm.

Meanwhile, the outer unit preferably includes a housing having the rotation driver of the handle grip inserted thereinto and including a convex groove and a convex groove formed therein, wherein the convex groove defines a swivel angle of the handle grip, and the convex groove for inserting a spherical elastic member gives elasticity to the handle grip and being integrally formed therein.

And, the inner unit preferably includes a housing having the rotation driver of the handle grip inserted thereinto and including a convex groove, a convex groove and a fixed clamp plate, wherein the convex groove defines a swivel angle of the handle grip, the convex groove for inserting a spherical elastic member gives elasticity to the handle grip, and the fixed clamp plate having two projections formed therein, the projections defining a swivel angle of the plunger.

The latch bolt driving means includes a disk having a first projection, two second projections and a rectangular through hole formed in its central protrusion and including a pinhole into which the locking pin is inserted, wherein the first projection is fixed in the rotation driver of the outer unit and associated between both ends of the elastic member to determine a swivel angle of the handle grip, the second projections pushing a lift plate upwards when revolving the handle grip; and a lift plate including a protruded plate being able to be ascended/descended in a vertical direction by means of the second projections when revolving the disk in order to push a slider of the mortise lock.

In the present invention, the dead bolt driving means preferably includes a rotary moving body coupled to a central protrusion of the disk, prevented from being revolved when the latch bolt driving means is operated by the handle grip of the outer unit and revolved at a predetermined angle in a left or right direction when the dead bolt is locked and unlocked, and including horizontal wings and a vertical convex groove to which the projected portion of the revolving body driving pin of the inner unit is coupled; a plunger including a pivot having a shoulder portion and a rectangular section for revolving the rotary moving body or preventing the rotary moving body from being revolved if it is inserted into the rectangular through hole of the disk to revolve the handle grip; a key revolving body having a groove and two projections formed therein, wherein the pivot of the plunger revolved by the motor of the inner unit when opening/closing the door is inserted into the groove through the hole of the mortise lock; a pair of revolving body driving sliders having protruded plates associated respectively with the horizontal wings of the rotary moving body when locking and unlocking the dead bolt; and a pair of elastic members for giving elasticity to the revolving body driving slider.

Meanwhile, the inner unit preferably includes a disk having a projection and a rectangular hole formed in its central protrusion, wherein the projection is fixed in the rotation driver and associated between both ends of the elastic member to determine a swivel angle of the handle grip; a rotary moving body driving pin having a projected portion and a rectangular projection, wherein the projected portion is revolved together when revolving the disk and inserted into the vertical convex groove formed in the rotary moving body of the outer unit to operate the latch bolt and the dead bolt by operating the lift plate and the revolving body driving slider of the outer unit when revolving the handle grip, and the rectangular projection is inserted into the rectangular hole of the disk; and a plunger for revolving a pair of gears and a rotation lever of the mortise lock together to lock and unlock the dead bolt, wherein the gears are revolved by receiving a driving force of the motor, and the rotation lever is fixed in the gear to revolve and counter-revolve the dead bolt at a predetermined angle.

The plunger preferably includes a stopper for defining a swivel angle of the plunger in a space between the two projections of the fixed clamp plate.

Meanwhile, the emergency release assembly preferably includes a body including an opening for inserting an emergency card and a reception groove and fixed in the housing of the outer unit; upper/lower plates for easily inserting the emergency card inserted into the opening of the body; an elastic plate for resiliently supporting the upper/lower plates against the body; a magnet-fixed clamp plate installed onto the upper plates and having through holes for receiving a plurality of cylindrical magnets, formed therein; a first slider having a plurality of cylindrical convex grooves and a spring reception groove formed therein and being able to be slid by the emergency card, the cylindrical convex grooves corresponding to the through holes of the magnet-fixed clamp plate; a plurality of magnets arranged between the magnet-fixed clamp plate and the first slider to permit the first slider to move only when a valid emergency card is inserted since it is operated by means of an impact and a repulsion of the emergency card when inserting the emergency card; a cover being able to be fixed in the body to receive the upper/lower plates, the elastic plate, the magnet-fixed clamp plate, the first slider and the magnets into the reception groove of the body, and simultaneously fixed in the housing and having an opening; a second slider fixed in the first slider through the opening of the cover and slid to give a bias force so that the rotary moving body and the plunger are revolved integrally; and a rod and a spring being able to be inserted into the reception groove to give elasticity to the first slider.

And, it is characterized in that a through hole for receiving a locking pin and a spring is formed in the rotary moving body of the outer unit; and the rotary moving body is revolved together with the plunger when the second slider moves forwards, and the rotary moving body allows the plunger of the inner unit to revolve the rotation lever of the mortise lock by operating the revolving body driving slider to revolve the key revolving body, thereby to manually unlock the dead bolt.

The door locking apparatus according to the present invention has one of the password recognition means using a keypad, the fingerprint recognition means using a fingerprint recognition device, and the card recognition means operated by the card reader, or has combinations thereof, or may have the password recognition means using a keypad, the fingerprint recognition means using a fingerprint recognition device, and the card recognition means operated by the card reader at the same time.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view showing installation of a door locking apparatus according to one preferred embodiment of the present invention.

FIG. 2 is an exploded perspective view showing a door locking apparatus according to the present invention.

FIG. 3a is a perspective view showing that a mortise lock used in the present invention is installed in an outer unit, which illustrates a locking function in which a dead bolt and a latch bolt are extruded from the mortise lock.

FIG. 3b is a perspective view showing that a mortise lock used in the present invention is installed in an outer unit, which illustrates a locking function in which a dead bolt and a latch bolt are retreated inward from the mortise lock at the same time.

FIG. 4 is an exploded perspective view showing a cover of the mortise lock used in the present invention.

FIG. 5 is an exploded perspective view showing the mortise lock as shown in FIG. 4.

FIG. 6 is a perspective view showing an inner unit used in the present invention.

FIG. 7 is an exploded perspective view showing an outer unit used in the present invention.

FIG. 8 is an exploded perspective view showing the inner unit as shown in FIG. 6.

FIG. 9 is an exploded perspective view showing an emergency release assembly as shown in FIG. 7.

FIG. 10a is a plane view showing an outer side of the inner unit.

FIG. 10b is a plane view showing that a locking state of the dead bolt is cancelled by revolving a rotary grip.

FIG. 11a to FIG. 11d are plane views showing an operation of components of an outer unit from which some components are removed in order to illustrate an operation of a latch bolt for opening/closing a door:

FIG. 11a is a plane view showing the outer unit illustrating that the dead bolt is retreated to unlock the door lock apparatus and the latch bolt is extruded.

FIG. 11b is a plane view showing the outer unit illustrating that a key revolving body is revolved to extrude the dead bolt of the mortise lock outwards when an external force is applied upward from a handle grip of the outer unit, thereby to lock the door lock apparatus, and simultaneously the latch bolt is retreated inwards by means of the latch bolt pushing stick.

FIG. 11c is a plane view showing the outer unit illustrating that the latch bolt is retreated outwards when the external force applied to the handle grip is cancelled under the condition as shown in FIG. 11b.

FIG. 11d is a plane view showing the outer unit illustrating that the key revolving body is not revolved to perform a locking state of the door lock apparatus continuously even when the external force is applied downwards from the handle grip of the outer unit under the condition as shown in FIG. 11c, and simultaneously the latch bolt is retreated inwards by means of the latch bolt pushing stick.

FIG. 12a to FIG. 12d are plane views showing an operation of an outer unit and a mortise lock illustrating an operation of the dead bolt for locking a door:

FIG. 12a is a plane view showing the outer unit and the mortise lock illustrating that the dead bolt is retreated to unlock the door lock apparatus and the latch bolt is extruded outwards;

FIG. 12b is a plane view showing the outer unit and the mortise lock illustrating that a key revolving body is revolved to extrude a dead bolt of a mortise lock outwards when an external force is applied upward from a handle grip of the outer unit, thereby to lock the door lock apparatus, and simultaneously the latch bolt is retreated inwards by means of the latch bolt pushing stick.

FIG. 12c is a plane view showing the outer unit and the mortise lock illustrating that the latch bolt is retreated outwards when the external force applied to the handle grip is cancelled under the condition as shown in FIG. 12b.

FIG. 12d is a plane view showing the outer unit and the mortise lock illustrating that only a plunger is revolved but the key revolving body is not revolved when the handle grip is revolved under the condition as shown in FIG. 12c, and therefore the dead bolt is continuously locked since the key revolving body is not revolved.

FIG. 12e is a plane view showing the outer unit and the mortise lock illustrating that an emergency card is inserted into an emergency release assembly to revolve the key revolving body manually when a power source is turned off under the condition as shown in FIG. 12c.

FIG. 13a is a cross-sectional view taken from a line XIIIa-XIIIa as shown in FIG. 12c.

FIG. 13b is a cross-sectional view taken from a line XIIIb-XIIIb illustrating an operation of the emergency card as shown in FIG. 12e.

FIG. 13c is a plane view showing an outer unit and a mortise lock illustrating that the key revolving body is revolved to unlock a door lock apparatus, and simultaneously the latch bolt is retreated inwards by means of the latch bolt pushing stick if an external force is applied downwards from a handle grip of the outer unit when the emergency card is inserted into the door lock apparatus.

FIG. 13d is a plane view showing an outer unit and a mortise lock illustrating that the door lock apparatus is unlocked to return to the normal condition as shown in FIG. 13a.

### DETAILED DESCRIPTION OF PREFERRED EMBODIMENTS

Hereinafter, preferable embodiments according to the present invention will be described with reference to the accompanying drawings. Here, when one element is connected to another element, one element may be not only directly connected to another element but also indirectly connected to another element via another element. Further, irrelative elements are omitted for clarity. Also, like reference numerals refer to like elements throughout.

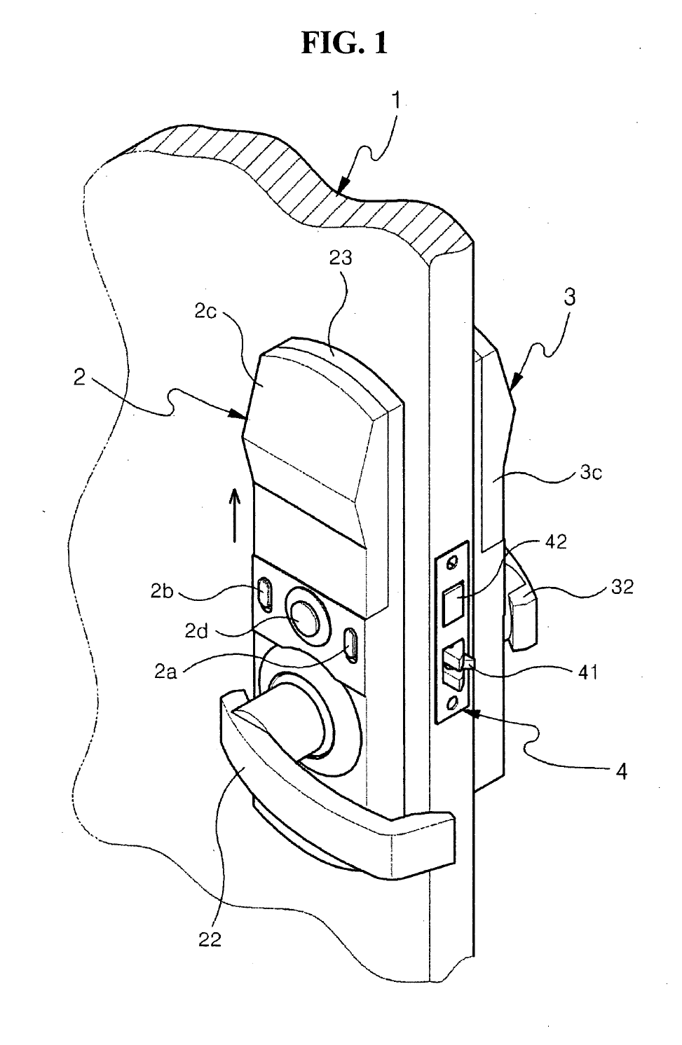

Referring to FIG. 1, the door locking apparatus of the present invention includes an inner unit 2 installed in one side of a door; and an outer unit 3 installed in the other side of the door 1 corresponding to the inner unit 2, wherein the inner and outer units 2,3 include handle grips 22,32, respectively. And, the mortise lock 4 including a latch bolt 41 and a dead bolt 42 is mounted inside the door 1.

In the inner unit 2 and the outer unit 3 according to the present invention, nearly all components except for an insulator are preferably manufactured with strong metal structures that are preventive to a fire and external damages, and particularly preferably manufactured so that the inner unit 2 and the outer unit 3 can have high strength and purity of a natural zinc surface appearance using a zinc die casting material and process.

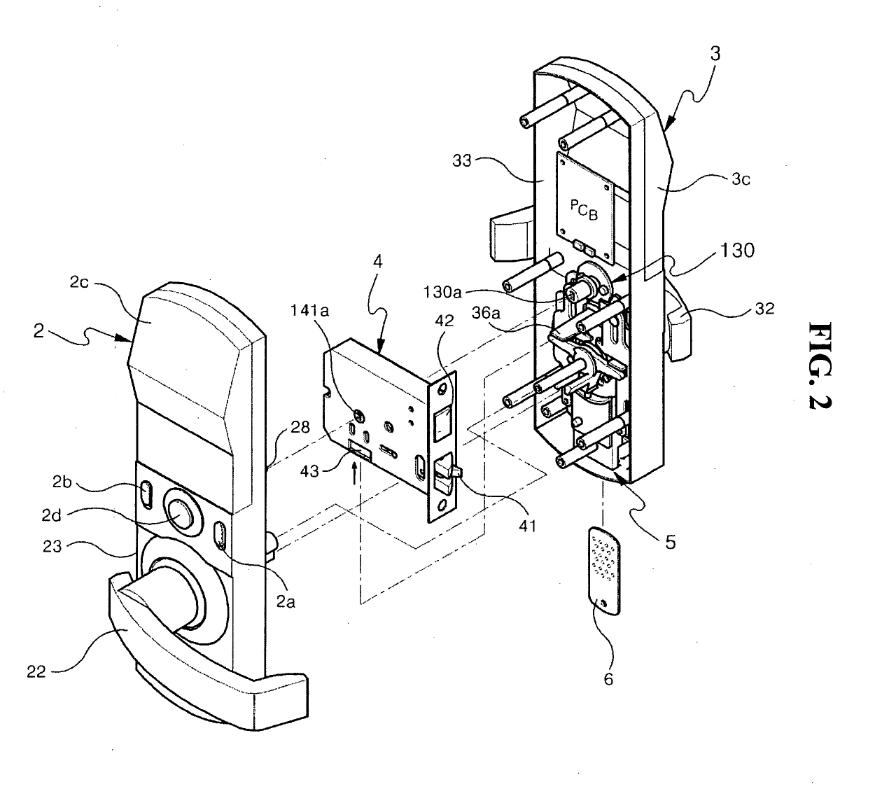

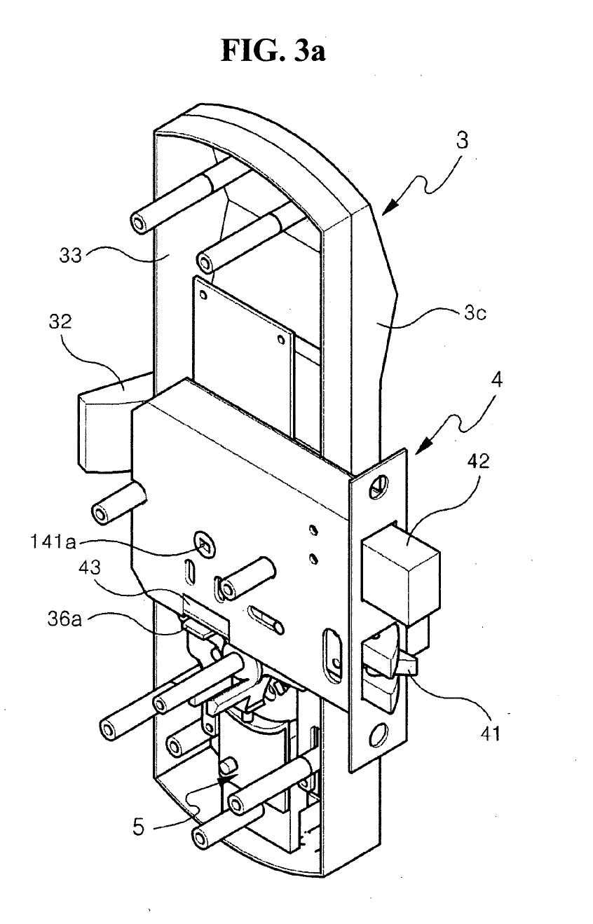

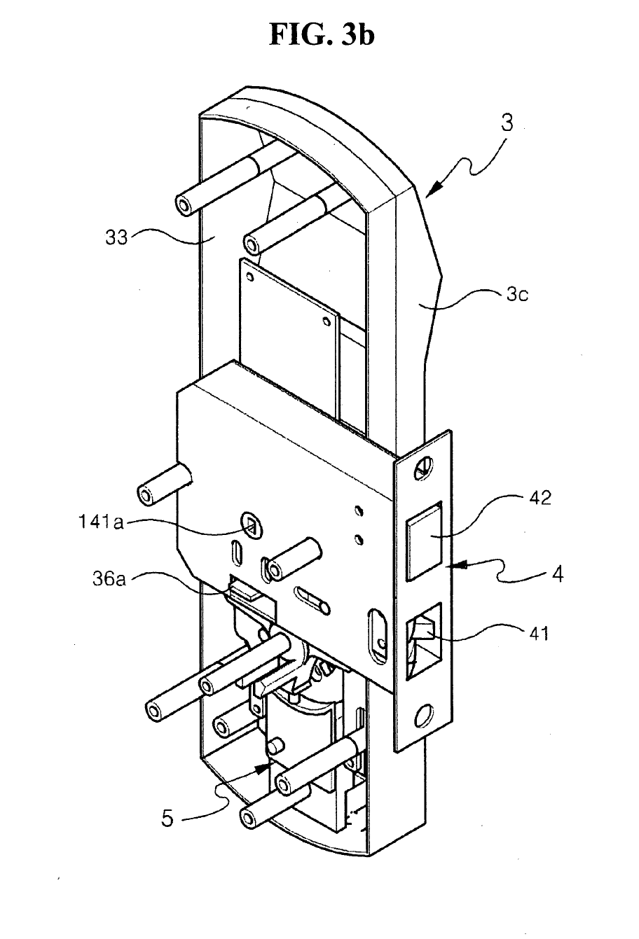

Meanwhile, the mortise lock 4 used in the present invention includes a door locking/unlocking latch bolt 41 operated by means of handle grips 22, 32 of the inner unit 2 and the outer unit 3; and a dead bolt 42 extruded and contracted by means of a driving force of a motor 21 installed in the inner unit 2 to lock/unlock a door. Accordingly, the mortise lock 4 used in the present invention has a different configuration from the conventional ones. That is to say, a slider 43 for driving the latch bolt 41 is operated by means of a protruded plate 36a of a lift plate 36 configured in the outer unit 3 since the slider 43 is arranged in a lower part of the mortise lock 4, as shown in FIG. 2 (see FIG. 3a and FIG. 3b).

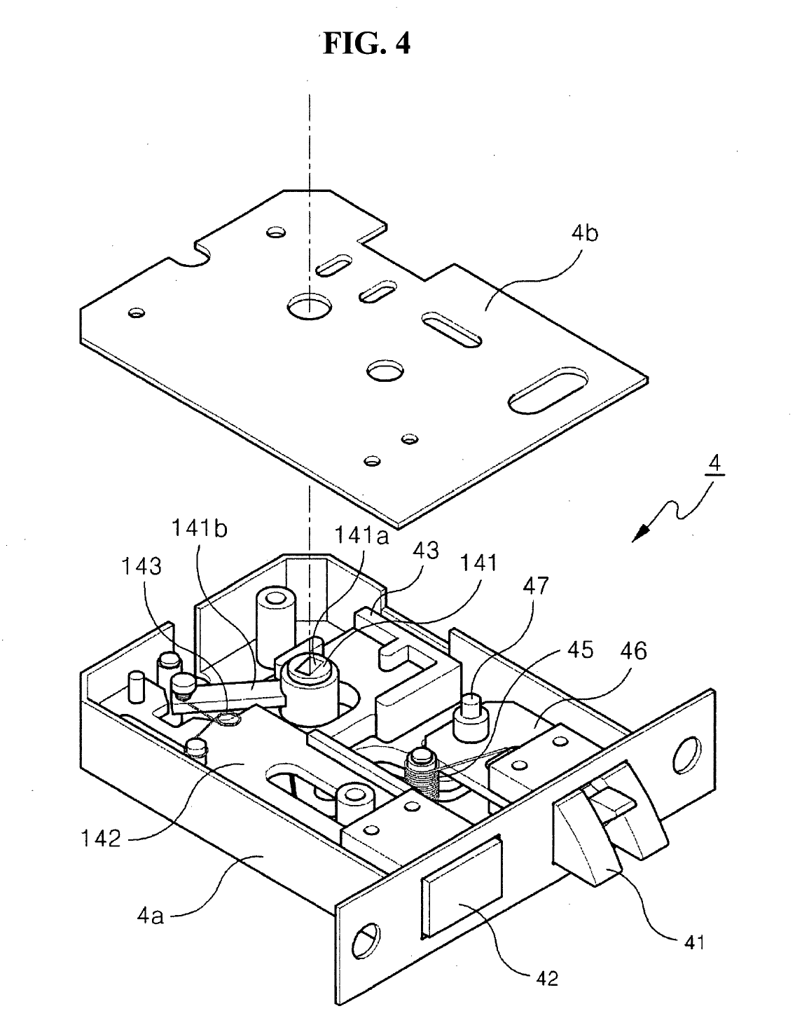

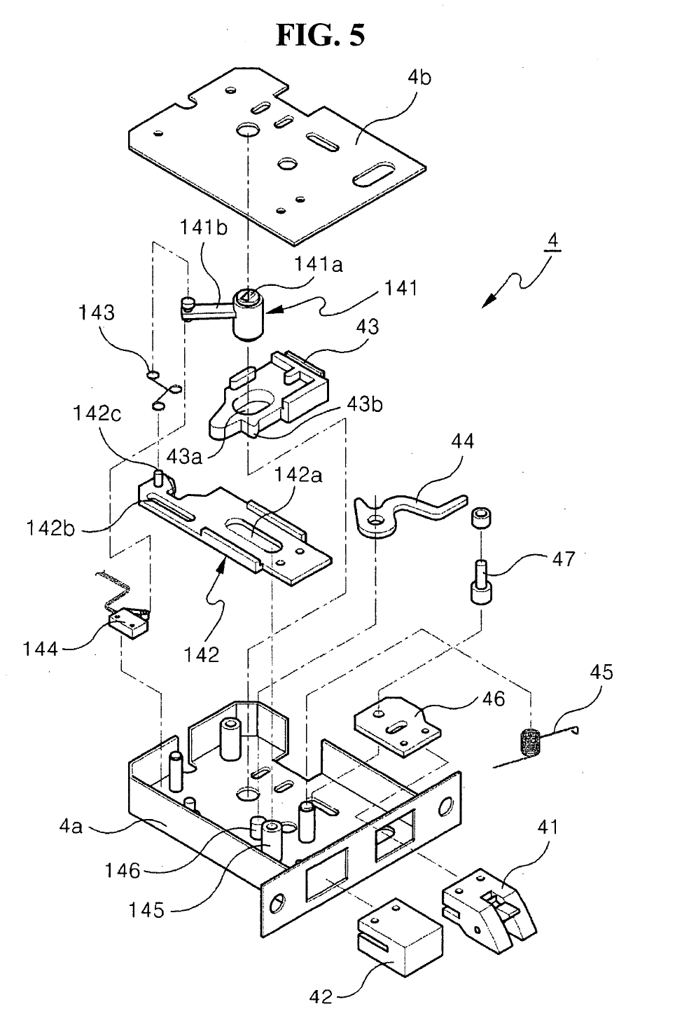

Referring to FIG. 4 and FIG. 5, the mortise lock 4 includes a housing 4a and a lid 4b. Then, a latch driving slider 43 is installed inside the housing 4a, the latch driving slider 43 including a groove 43a slid when the handle grips 22,32 of the inner and outer units 2,3 is revolved independently and receiving a rotation lever 141; and a shoulder portion 43b for driving a link member 44.

As shown in FIG. 5, a link member 44 and an elastic member 45 are installed inside the housing 4a, wherein the link member 44 is engaged with the latch driving slider 43 to operate the latch bolt 41, thereby to open/close a door, and the elastic member 45 serves to give elasticity to the latch driving slider 43 when it is operated by the link member 44. Then, the elastic member 45 is shown as a torsion spring, but the other kinds of springs may also be used herein.

And, the elastic member 45 includes a drive plate 46 into which the latch bolt 41 are fixed; and a pin 47 fixed in the drive plate 46 and associated with one end of the link member 44, and therefore it can open/close the latch bolt 41.

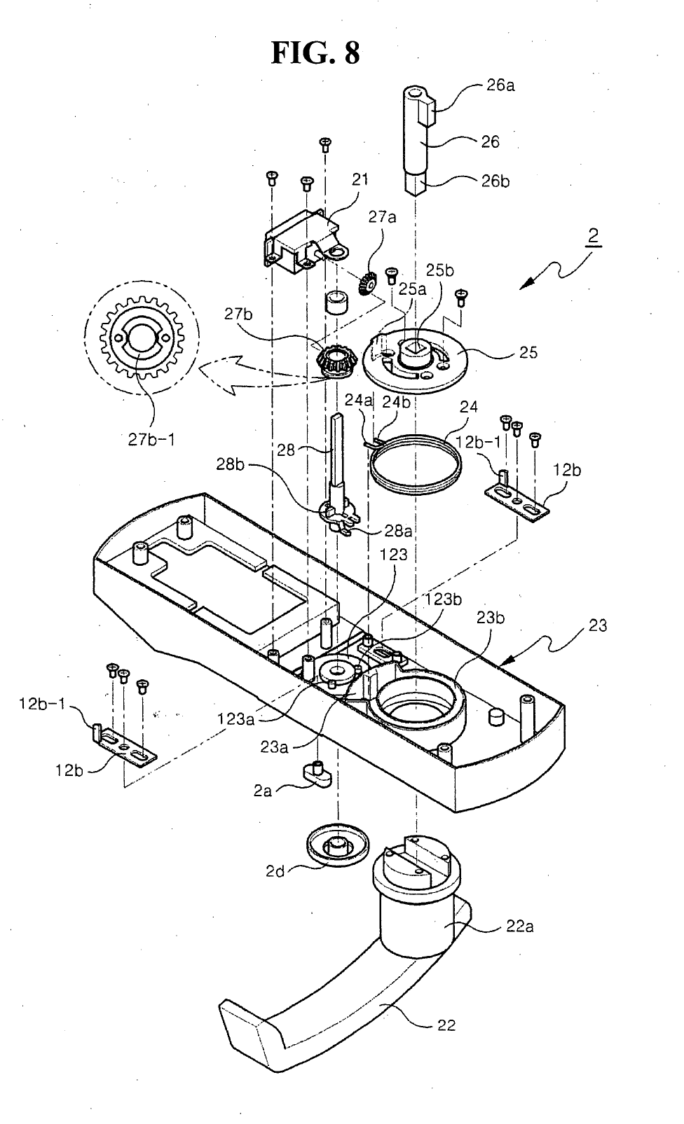

Meanwhile, the mortise lock 4 further includes a rotation lever 141 having a hole 141a through which a pivot of the plunger 28 (see FIG. 8) is passed so that it can be revolved together when revolving a motor 21 installed in the inner unit 2, and a dead bolt transfer arm 141b; a dead bolt drive plate 142 having a dead bolt 42 fixed in its one end and receiving guide slot 142a,142b and a dead bolt transfer arm 141b; and a spring as an elastic member 143 for resiliently driving the dead bolt drive plate 142 when operating the transfer arm 141b, and also include a switch 144 for providing a forward and backward movement of the dead bolt drive plate 142 to a controller apparatus which is installed in a printed circuit board (PCB) inside the outer unit 3, which will be described later, wherein a guide rod 145 is fixed in the guide slot 142a.

Referring to FIG. 8, the inner unit 2 has a rotation driver 22a of the handle grip 22 inserted thereinto, and has housing 23 formed therein, wherein the housing 23 includes a convex groove 23a for defining a swivel angle of the handle grip 22, a convex groove 23b for inserting a spherical elastic member 24, and a housing 23 having a fixed clamp plate 123 formed therein, the convex groove 23b giving elasticity to the handle grip 22, and the fixed clamp plate 123 including two projections 123a,123b for defining a swivel angle of the plunger 28.

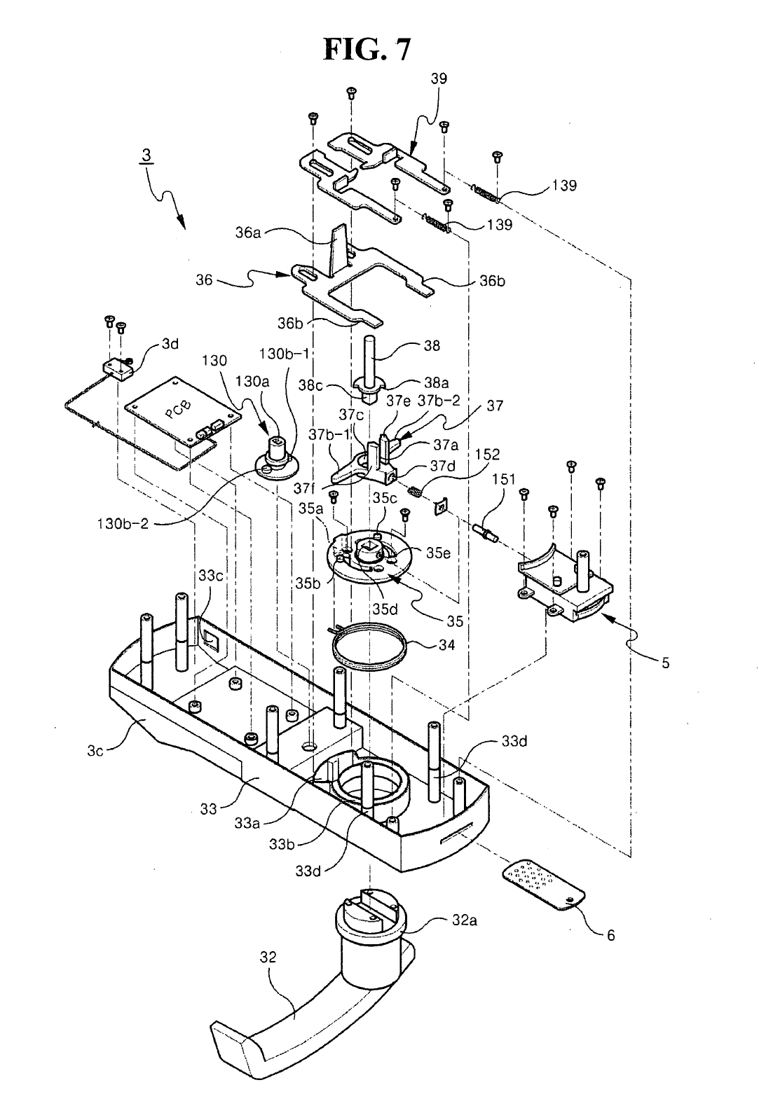

Referring to FIG. 7, the outer unit 3 has a rotation driver 32a of a handle grip 32 inserted thereinto, and includes a housing 33 having a convex groove 33a for defining a swivel angle of the handle grip 32; and a convex groove 33b for inserting a spherical elastic member 34 integrally formed therein, wherein the convex groove 33b gives elasticity to the handle grip 32.

Meanwhile, the door locking apparatus according to the present invention includes a latch bolt driving means for operating a latch bolt 41; and a dead bolt driving means for operating a dead bolt 42, and will be described in more detail.

Referring to FIG. 7, the latch bolt driving means used in the present invention includes a disk 35 and a lift plate 36 for pushing a slider 43 of the mortise lock 4, wherein the disk 35 has a first projection 35a fixed in the rotation driver 32a of the outer unit 3 and associated between both ends of the elastic member 34 to determines a swivel angle of the handle grip 32, two second projections 35b,35c for pushing a lift plate 36 when revolving the handle grip 32, and a pinhole 35e having a rectangular through hole 35d formed in a central protrusion and a locking pin 151 inserted thereinto; and the lift plate 36 includes a protruded plate 36a being able to be ascended/descended in a vertical direction by means of the second projections 35b,35c when revolving the disk 35.

And, the dead bolt driving means used in the present invention is coupled to the central protrusion of the disk 35, not revolved when the latch bolt driving means is operated by the handle grip 32 of the outer unit 3 and revolved at a predetermined angle in a left or right direction when the dead bolt 42 is locked and unlocked, and includes a rotary moving body 37 coupled to a central protrusion of the disk 35, prevented from being revolved when the latch bolt driving means is operated by the handle grip 32 of the outer unit 3 and revolved at a predetermined angle in a left or right direction when the dead bolt 42 is locked and unlocked, and including horizontal wings 37b-1,37b-2 and a vertical convex groove 37a to which the projected portion 26a of the revolving body driving pin 26 of the inner unit is coupled; a plunger 38 including a pivot having a shoulder portion 38a and a rectangular section 38c for revolving the rotary moving body 37 or preventing the rotary moving body 37 from being revolved if it is inserted into the rectangular through hole 35d of the disk 35 to revolve the handle grip 32; a key revolving body 130 having a groove 130a and two projections 130b-1,130b-2 formed therein, wherein the pivot of the plunger 28 revolved by the motor 21 of the inner unit 2 when opening/closing the door is inserted into the groove 130a through the hole 141a of the mortise lock 4; a pair of revolving body driving sliders 39 having protruded plates 39a, 39b associated respectively with the horizontal wings 37b-1,37b-2 of the rotary moving body 37 when locking and unlocking the dead bolt 42; and tensile springs as a pair of elastic members 139 for giving elasticity to the revolving body driving slider 39.

Referring to FIG. 8 again, the inner unit 2 used in the present invention includes a disk 25 having a projection 25a and a rectangular hole 25b formed in its central protrusion, wherein the projection 25a is fixed in the rotation driver 22a and associated between both ends of the elastic member 24 to determine a swivel angle of the handle grip 22; a rotary moving body driving pin 26 having a projected portion 26a and a rectangular projection 26b, wherein the projected portion 26a is revolved together when revolving the disk 25 and inserted into the vertical convex groove 37a formed in the rotary moving body 37 of the outer unit 3 to operate the latch bolt 41 and the dead bolt 42 by operating the lift plate 36 and the revolving body driving slider 39 of the outer unit 3 when revolving the handle grip 22, and the rectangular projection 26b is inserted into the rectangular hole 25b of the disk 25; and a plunger 28 for revolving a pair of gears 27a,27b and a rotation lever 141 of the mortise lock together to lock and unlock the dead bolt 42, wherein the gears 27a,27b are revolved by receiving a driving force of the motor 21, and the rotation lever 141 is fixed in the gear 27b to revolve and counter-revolve the dead bolt 42 at a predetermined angle.

And, the plunger 28 includes a stopper 28a for defining a swivel angle of the plunger 28 in a space between two projections 123a, 123b of the fixed clamp plate 123, and therefore an end of the plunger 28 is fit into the key groove 130a of the key revolving body 130 through the hole 141a of the rotation lever 141 of the mortise lock 4 when the plunger 28 is installed in the door 1, as shown in FIG. 2. Accordingly, the rotation lever 141 of the mortise lock 4 may be revolved to lock or unlock the dead bolt 42, and simultaneously the key revolving body 130 may also be revolved if the plunger 28 of the inner unit 2 is revolved as shown in FIG. 2, FIG. 4 and FIG. 8.

Accordingly, the rotation lever 141 of the mortise lock 4 is configured so that it can be revolved by the plunger 28 which is revolved by the motor 21 installed in the inner unit 2, or revolved by the key revolving body 130 installed in the outer unit 3.

Meanwhile, the door locking apparatus of the present invention includes an emergency release assembly capable of inserting a metal card having a magnet installed inside if a power source such as a dry battery is not supplied or if the locking apparatus is not used due to other mechanical defects. As shown in FIG. 7, the emergency release assembly 5 is mounted inside the outer unit 3, and engaged with the handle grip 32 of the outer unit 3 in order to unlock the locked dead bolt 42 if a power source supplied to the motor is shut off. Accordingly, the emergency card 6 having a permanent magnet installed inside is inserted into the emergency release assembly 5 to unlock the dead bolt 42.

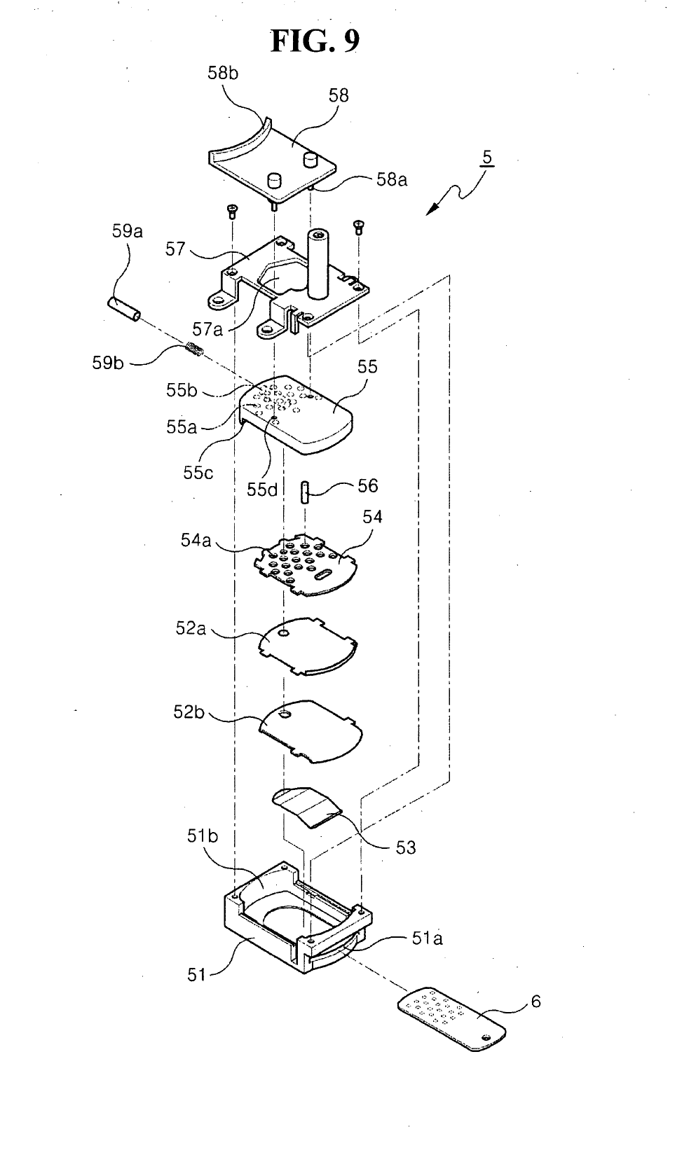

Referring to FIG. 9, the emergency release assembly 5 includes a body 51 having an opening 51a for inserting an emergency card 6 and a reception groove 51b and fixed in the housing 33 of the outer unit 3; upper/lower plates 52a, 52b for easily inserting the emergency card 6 inserted into the opening 51a of the body 51; an elastic plate 53 for resiliently supporting the upper/lower plates 52a,52b against the body 51; and a magnet-fixed clamp plate 54 mounted onto the upper plates 52a and including through holes 54a for receiving a plurality of cylindrical magnets.

Also, the emergency release assembly 5 includes a first slider 55 having a plurality of cylindrical convex grooves 55a and a spring reception groove 55b formed therein and being able to be slid by the emergency card 6, the cylindrical convex grooves 55a corresponding to the through holes 54a of the magnet-fixed clamp plate 54; a plurality of magnets 56 arranged between the magnet-fixed clamp plate 54 and the first slider 55 to permit the first slider 55 to move only when a valid emergency card is inserted since it is operated by means of an impact and a repulsion of the emergency card 6 when inserting the emergency card 6; a cover 57 being able to be fixed in the body 51 to receive the upper/lower plates 52a,52b, the elastic plate 53, the magnet-fixed clamp plate 54, the first slider 55 and the magnets 56 into the reception groove 51b of the body 51, and simultaneously fixed in the housing 33 and having an opening 57a; and a second slider 58 fixed in the first slider 55 through the opening 57a of the cover 57 and slid to give a bias force so that the rotary moving body 37 and the plunger 38 are revolved integrally.

And, a rod 59a is elastically inserted into the reception groove 55b using a spring 59b in order to give elasticity to the first slider 55.

Referring to FIG. 7 again, a through hole 37d for receiving a locking pin 151 and a spring 152 is formed in the rotary moving body 37 of the outer unit 3, and the rotary moving body 37 is revolved together with the plunger 38 when the second slider 58 moves forwards, and the rotary moving body 37 allows the plunger 28 of the inner unit 2 to revolve the rotation lever 141 of the mortise lock 4 by operating the revolving body driving slider 39 to revolve the key revolving body 130, thereby to manually unlock the dead bolt 42.

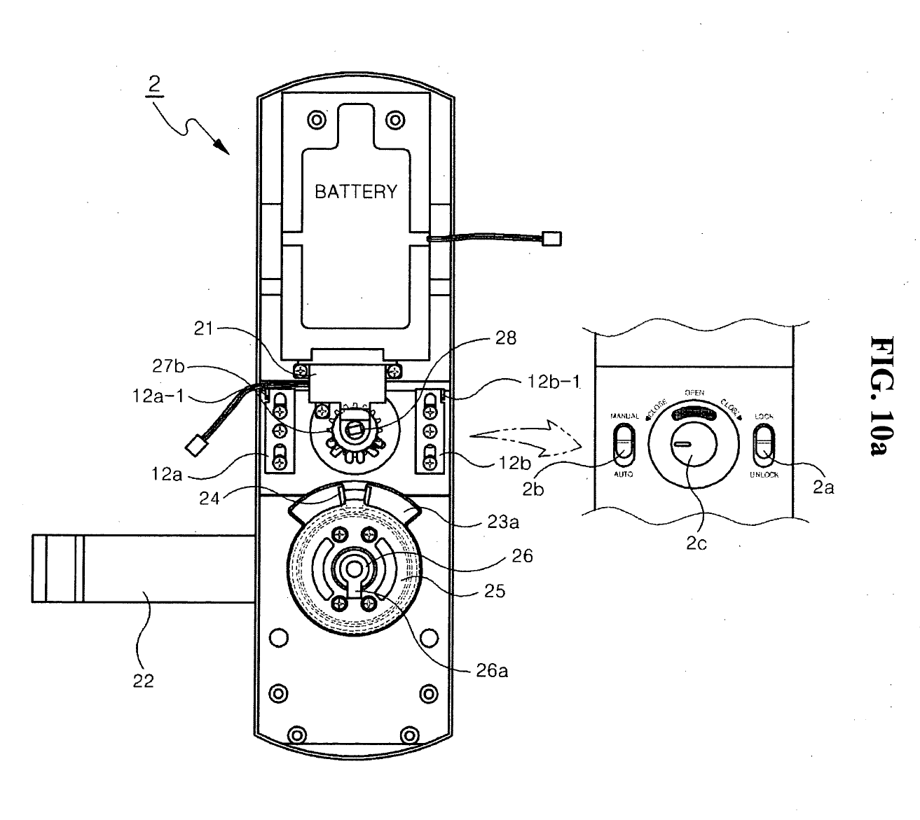

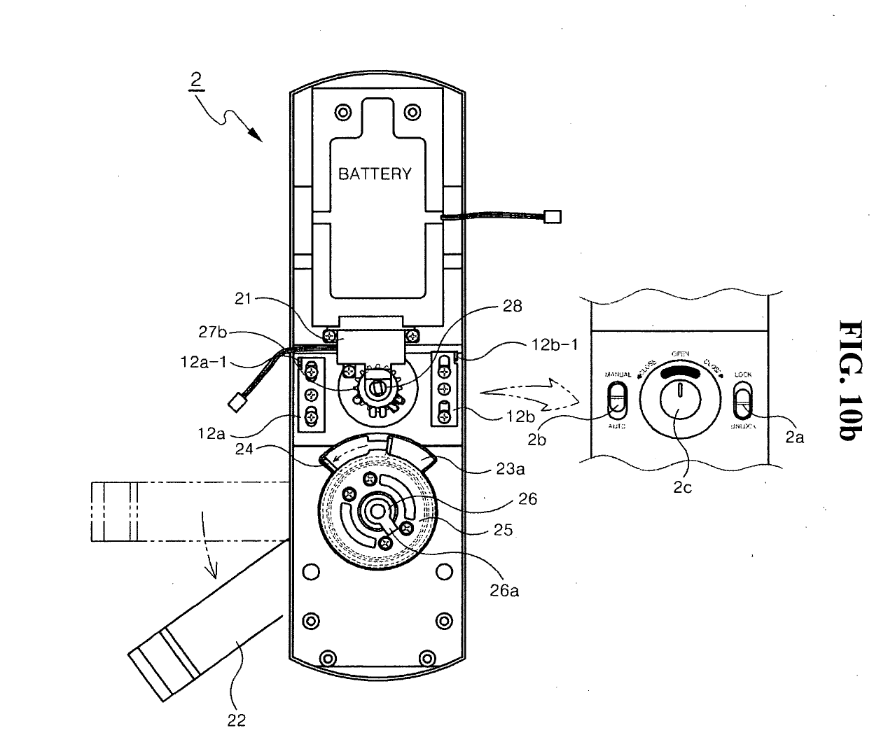

Referring to FIG. 10a and FIG. 10b, a transfer knob 2a for locking and unlocking a door inside a building, a transfer knob 2b for operating a door automatically or manually and a cap 2d for displaying an operating state of a dead bolt 42 are provided in the inner unit 2, and, referring to FIG. 1, a battery cover 2c is provided in the inner unit 2, and therefore a battery may be exchanged by pushing the cover 2c upward in an arrow direction.

Meanwhile, a cover 3c is formed in the outer unit 3 as shown in FIG. 3a and FIG. 3b, and therefore a door may be opened by input of the password since the cover 3c has various digital key pads (not shown) as in the conventional door locks.

And, a printed circuit board (PCB) is fixed inside the housing 33 of the outer unit 3, wherein electronic circuits for sensing a password or recognizing a fingerprint or recognition circuits using a card reader are installed in the printed circuit board (PCB), as shown in FIG. 7, and an opening 33c is formed in one side of the housing 33, wherein a sensor switch 3d for sensing an opened state of the cover 3c is installed in the opening 33c.

Also, referring to FIG. 8, switches 12a, 12b engaged with transfer knobs 2a, 2b of the housing 23 of the inner unit 2 are slidingly fixed, and projections 12a-1,12b-1 are formed in the switches 12a, 12b, respectively, and therefore a door allows a sensor switch (not shown) to supply a signal to the printed circuit board (PCB), the signal serving to lock/unlock the door in a manual/automatic manner (see FIG. 7).

And, a convex groove 27b-1 is preferably formed in a lower side of the gear 27b, and therefore two projections 28b of the plunger 28 slightly flow in the convex groove 27b-1, as shown in the exploded view of FIG. 8.

Meanwhile, in the door locking apparatus of the present invention, a transparent window or a card reader for recognizing a fingerprint may be provided outside the handle grip 32 of the outer unit 3 as shown in FIG. 7, or in the housing 23 in order to apply to the door lock having a card recognition means that is operated by the fingerprint recognition means using a fingerprint recognition device and the card reader, and therefore the transparent window or the card reader is omitted for simplification of the drawings in the present invention, but the present invention is not limited thereto.

The door locking apparatus of the present invention configured thus will be described in more detail, and the plane view of the outer unit 3 is shown while excluding some components for convenience' sake in order to clearly describe the operations of the latch bolt 41 and the dead bolt 42.

1. Description of Operation of Latch Bolt for Opening/Closing a Door:

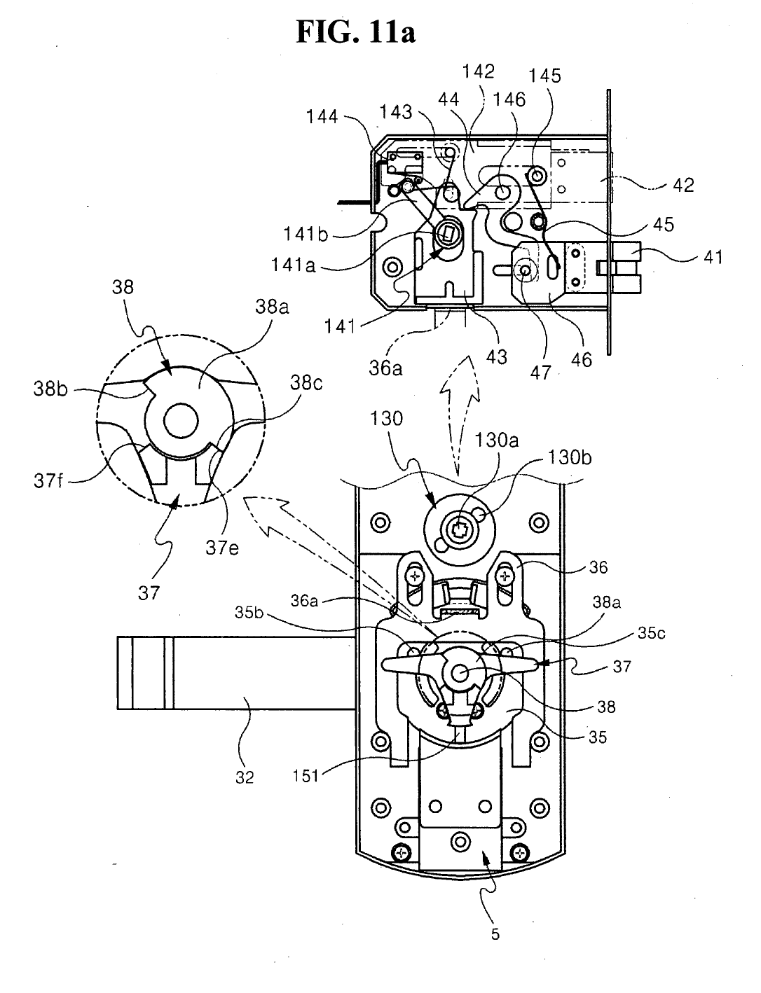

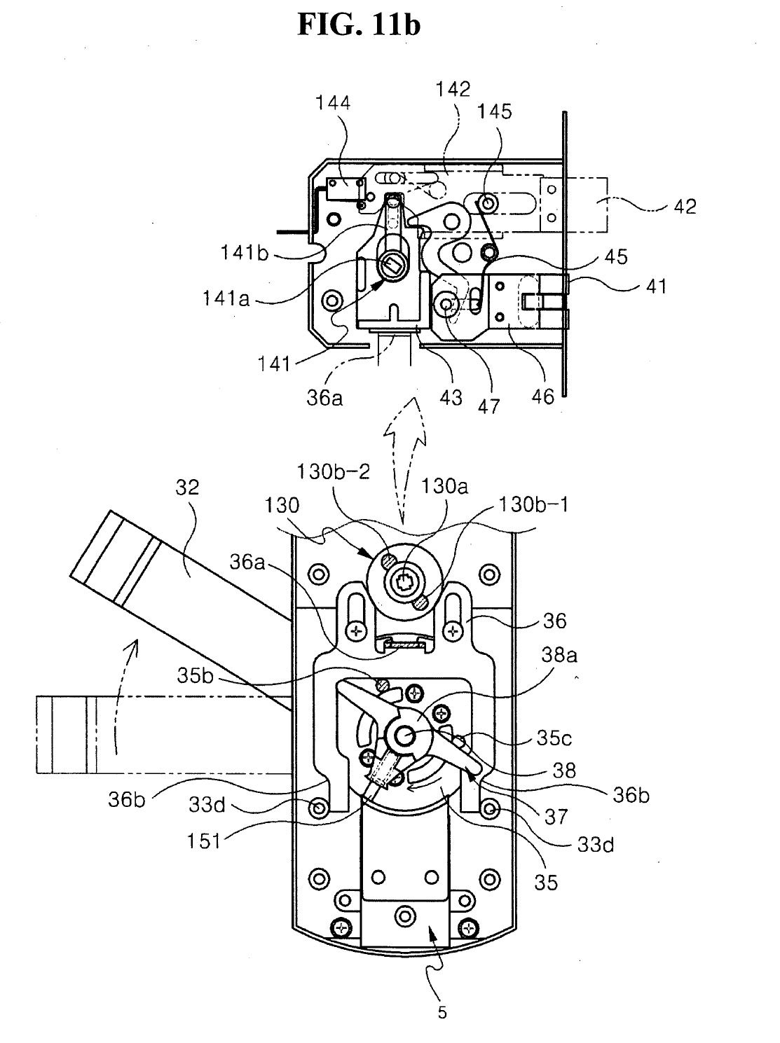

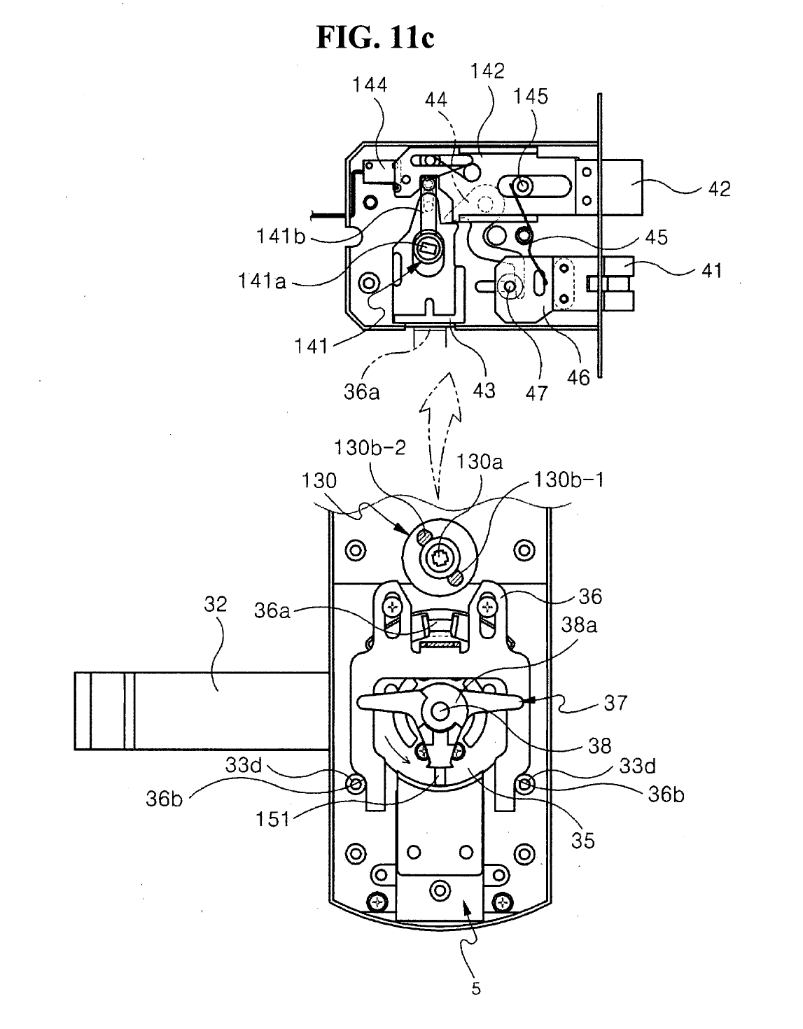

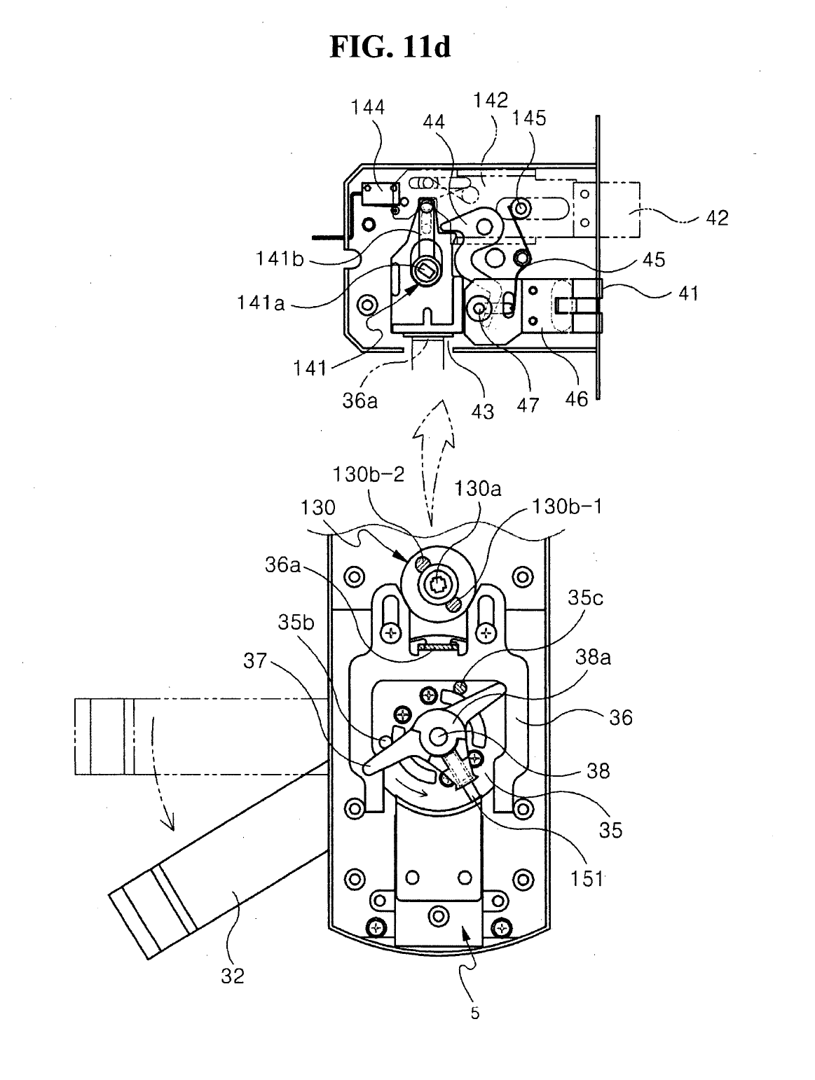

FIG. 11a to FIG. 11d show plane views showing an operation of components of the outer unit 3 and the mortise lock 4 from which some components are removed in order to illustrate an operation of a latch bolt for opening/closing a door.

Referring to FIG. 11a, at first, assume that the drawing of FIG. 11a is maintained in a beginning state, that is, in a state where a latch bolt 41 is extruded, or a dead bolt 42 is unlocked since a handle grip 32 of the outer unit 3 is not operated for convenience' sake.

If the handle grip 32 is pushed upwards under the condition of FIG. 11a as shown in FIG. 11b (if the handle grip 32 is revolved clockwise as shown in FIG. 11b), a disk 35 fixed in a rotation driver 32a of the handle grip 32 is revolved in an arrow direction. In this case, a first projection 35a of the disk 35 as shown in FIG. 7 pushes a free end of an elastic member 34, and a second projection 35b of the disk 35 pushes a lift plate 36 upwards, and therefore a protruded plate 36a of the lift plate 36 pushes a latch driving slider 43 of the mortise lock 4.

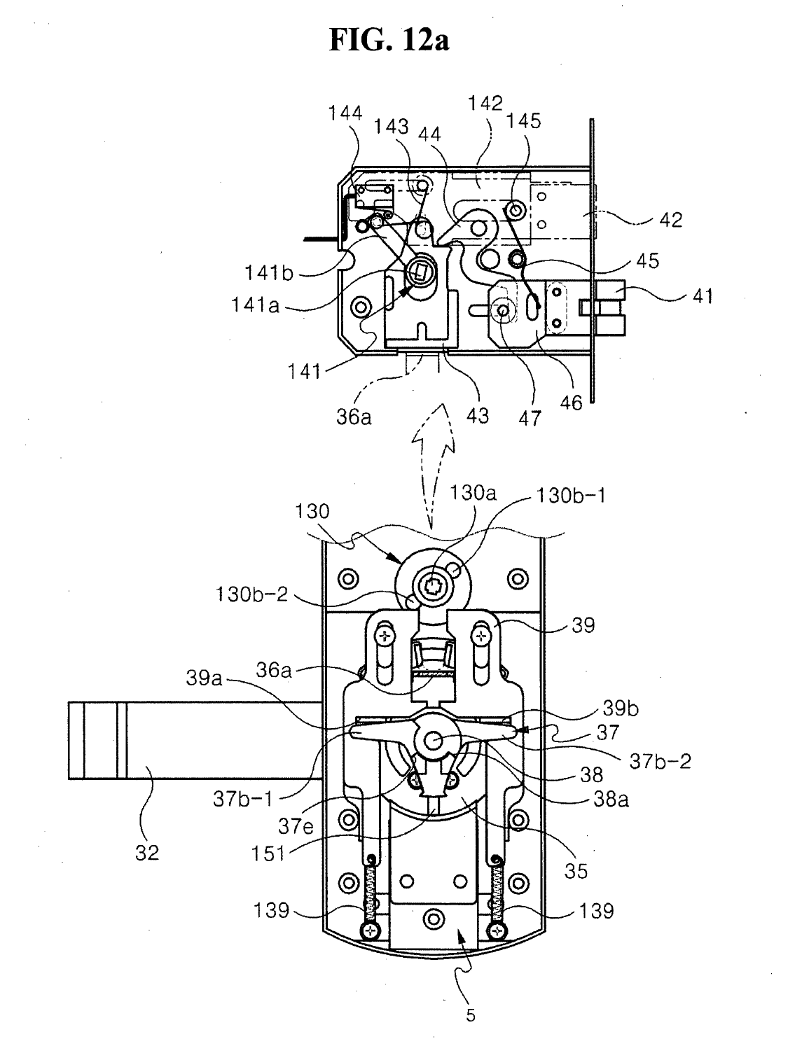

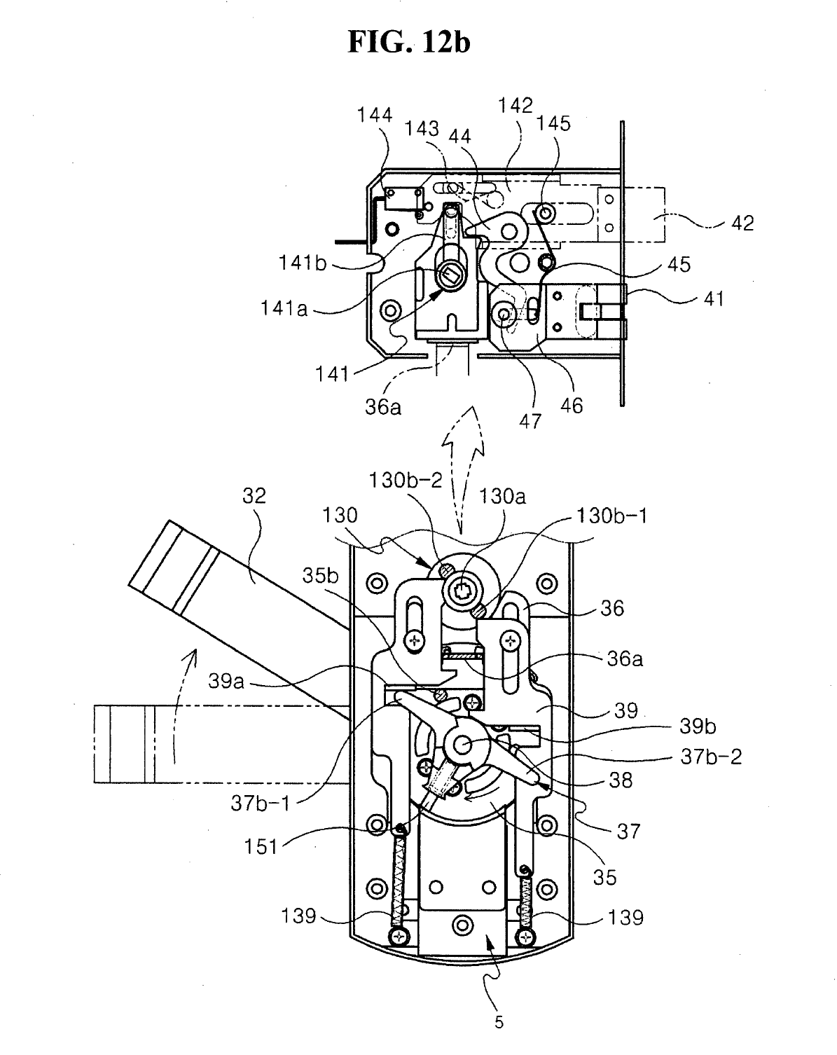

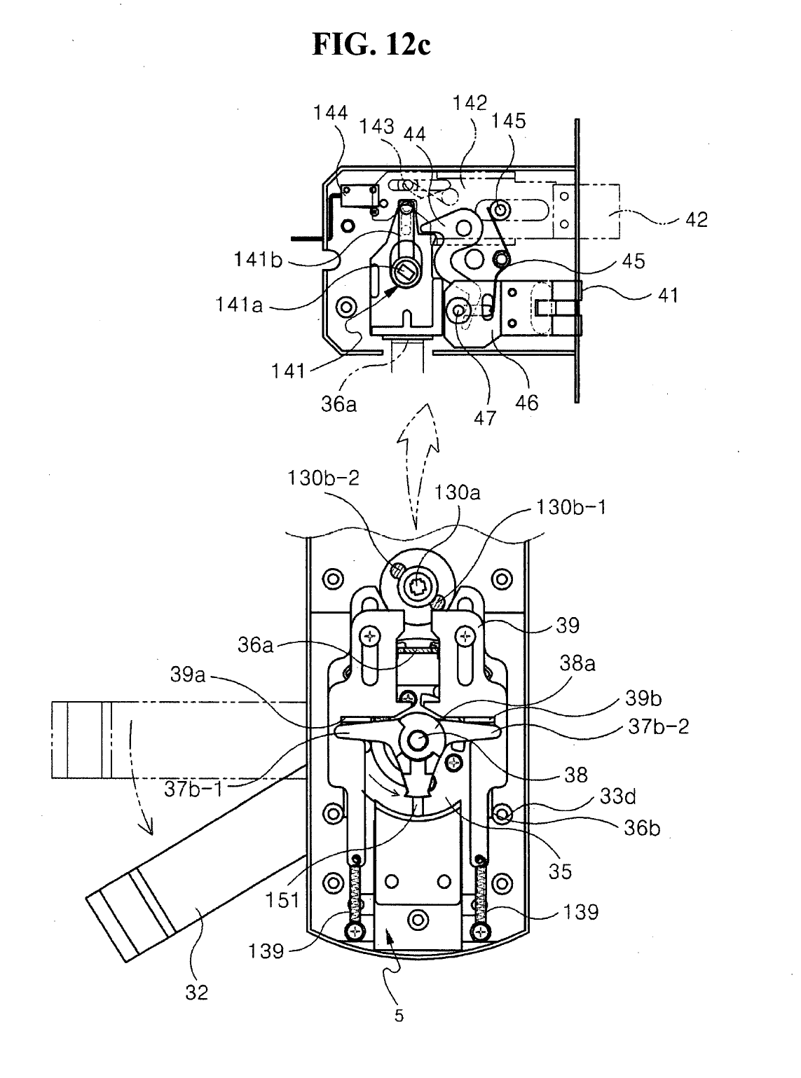

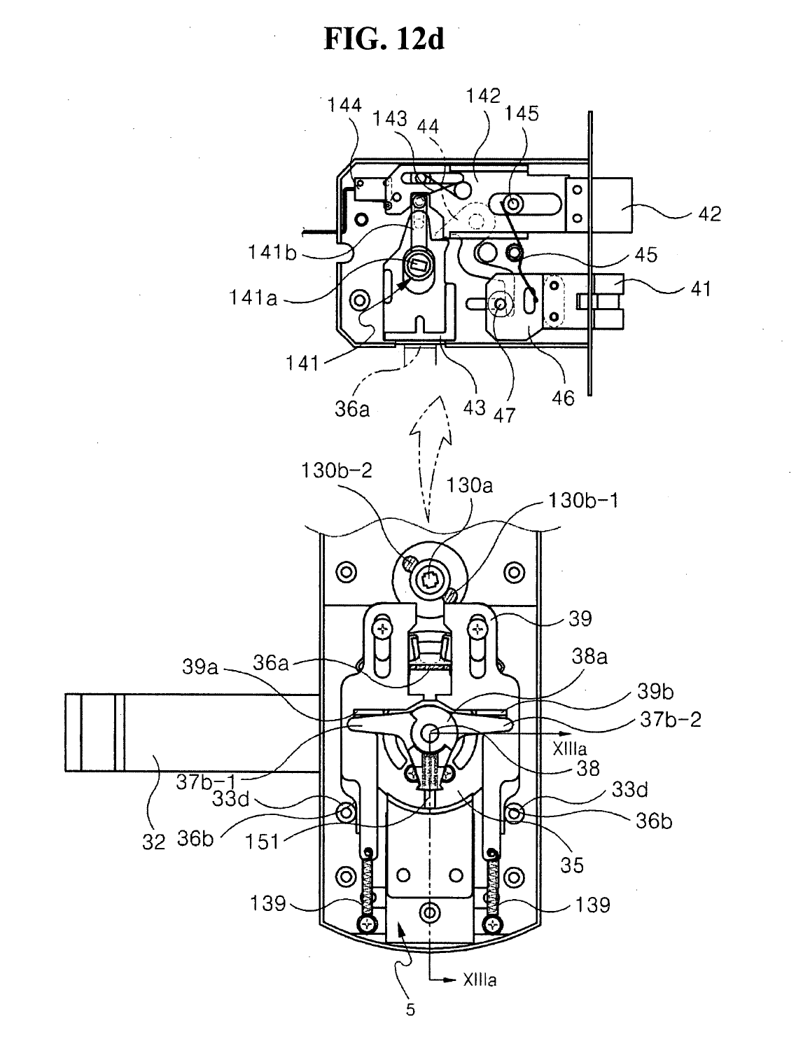

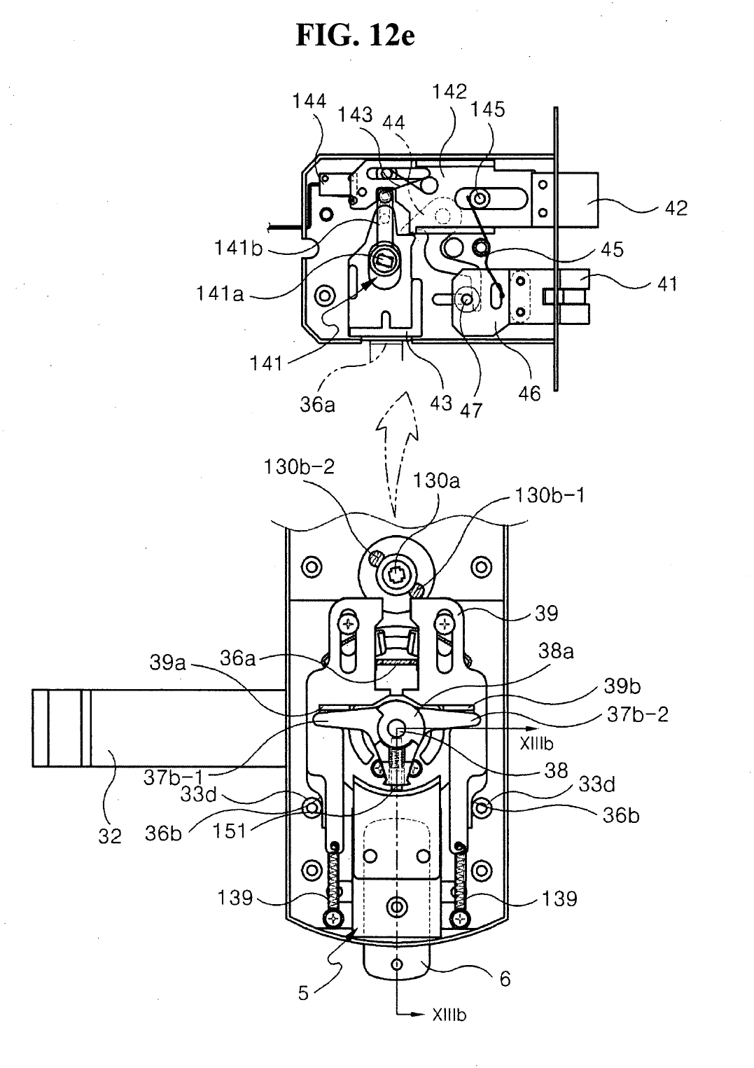

If the latch driving slider 43 is pushed upwards form the condition of FIG. 11a as described above, a shoulder portion 43b of a slider 43 of the mortise lock 4 pushes one end of a link member 44. Accordingly, the link member 44 is revolved clockwise in the center of a pivot 146, and therefore the other free end of the link member 44 pushes a pin 47 to a left direction, and then a latch bolt 41 is expanded and contracted inwards a case of the mortise lock 4, as shown in FIG. 11b. As shown in FIG. 11b, a dead bolt 42 is extruded, but the dead bolt 42 is omitted herein since it will be described later with reference to FIG. 12b.

Thus, if the handle grip 32 of the outer unit 3 is horizontally pushed upwards (revolved) as shown in FIG. 11b, the latch bolt 41 may be retreated and the dead bolt 42 may be extruded outwards.

However, if a force applied to the handle grip 32 is removed when the handle grip 32 is pushed upwards as shown in FIG. 11b, the free ends of the elastic member 34, which are wide opened as shown in FIG. 7, are contracted, and therefore the first projection 35a of the disk 35 is returned to the initial state by means of a restoring force of the free end of the elastic member 34. In this case, the disk 35 is returned to the normal state since it is revolved counterclockwise, as shown in FIG. 11c.

If the disk 35 is returned to the normal state as described above, the lift plate 36 moves down by means of a dead weight. At this time, an interfacial portion 36b of the lift plate 36 does not further move down since it hangs on a stopper 33d formed in the housing 33.

Accordingly, if the disk 35 is returned to the normal state by means of the elastic member 34, the protruded plate 36a of the lift plate 36 moves down, and therefore the drive plate 46 of the mortise lock 4 is resiliently operated by means of a restoring force of the elastic member 45, and then the latch bolt 41 is extruded inwards the mortise lock 4, thereby to sustain the state of FIG. 11c.

However, a locking state of the door locking apparatus is sustained since the rotation lever 141 is not revolved as long as the dead bolt 42 of the mortise lock 4 is forcibly revolved, and this will be described later with reference to FIG. 12a to FIG. 12d.

If the handle grip 32 moves down under the condition of FIG. 11c as shown in FIG. 11d (if it is revolved counterclockwise), the disk 35 fixed in the rotation driver 32a of the handle grip 32 is revolved in an arrow direction. In this case, the first projection 35a of the disk 35 as shown in FIG. 7 pushes the other free end of the elastic member 34, and the second projection 35c of the disk 35 pushes the lift plate 36 upwards, and therefore the protruded plate 36a of the lift plate 36 pushes the latch driving slider 43 of the mortise lock 4.

If the latch driving slider 43 is pushed upwards from the condition of FIG. 11c as described 2 above, the shoulder portion 43b of the slider 43 of the mortise lock 4 pushes one end of the link 3 member 44. Accordingly, the link member 44 is revolved clockwise in the center of the pivot 146, 4 and therefore the other free end of the link member 44 pushes the pin 47 in a left direction. Therefore, the latch bolt 41 is expanded and contracted inwards a case of the mortise lock 4, as shown in FIG. 11d.

If a force applied to the handle grip 32 is removed form the condition of FIG. 11d, the handle grip 32 is returned to the normal state again, as described above with reference to the FIG. 11c.

If the handle grip 32 of the outer unit 3 is operated up and down as described above (if it is revolved clockwise or counterclockwise), only the latch bolt 41 may be locked and unlocked.

2. Description of Operation of Dead Bolt for Locking and Unlocking a Door:

FIG. 12a to FIG. 12d show plane views showing an operation of the outer unit illustrating an operation of the dead bolt for locking a door. At first, FIG. 12a is a plane view showing the outer unit 3 and the mortise lock 4 illustrating that the dead bolt 42 is retreated to unlock the door lock 16 apparatus and the latch bolt 41 is extruded outwards, which is substantially identical to the diagram 17 as shown in FIG. 11a.

Referring to FIG. 12b, if the handle grip 32 is pushed upwards under the condition of FIG. 12a as shown in FIG. 12b (if it is revolved clockwise), a disk 35 fixed in a rotation driver 32a of the handle grip 32 is revolved in an arrow direction, as described above with reference to FIG. 11b. In this case, a first projection 35a of the disk 35 as shown in FIG. 7 pushes a free end of an elastic member 34, and a second projection 35b of the disk 35 pushes a lift plate 36 upwards, and therefore a protruded plate 36a of the lift plate 36 pushes a latch driving slider 43 of the mortise lock 4.

If the latch driving slider 43 is pushed upwards form the condition of FIG. 11a as described above, a shoulder portion 43b of a slider 43 of the mortise lock 4 pushes one end of a link member 44. Accordingly, the link member 44 is revolved clockwise in the center of a pivot 146, and therefore the other free end of the link member 44 pushes a pin 47 to a left direction, and then a latch bolt 41 is expanded and contracted inwards a case of the mortise lock 4, as shown in FIG. 11b.

Meanwhile, if the disk 35 is revolved, a shoulder portion 38a of a plunger 38, which is inserted into a rectangular through hole 35d formed in a central protrusion of the disk 35, is associated with a projection 37e of a rotary moving body 37, and therefore the rotary moving body 37 is also revolved together with the disk 35.

Accordingly, when the rotary moving body 37 is revolved, a horizontal wing 37b-1 of the rotary moving body 37 pushes a protruded plate 39a of a revolving body driving slider 39 upwards, and therefore the key revolving body 130 is revolved by associating an end of the slider 39 with a projection 130b-2 of the key revolving body 130 under the condition of FIG. 12a, as shown in FIG. 12b.

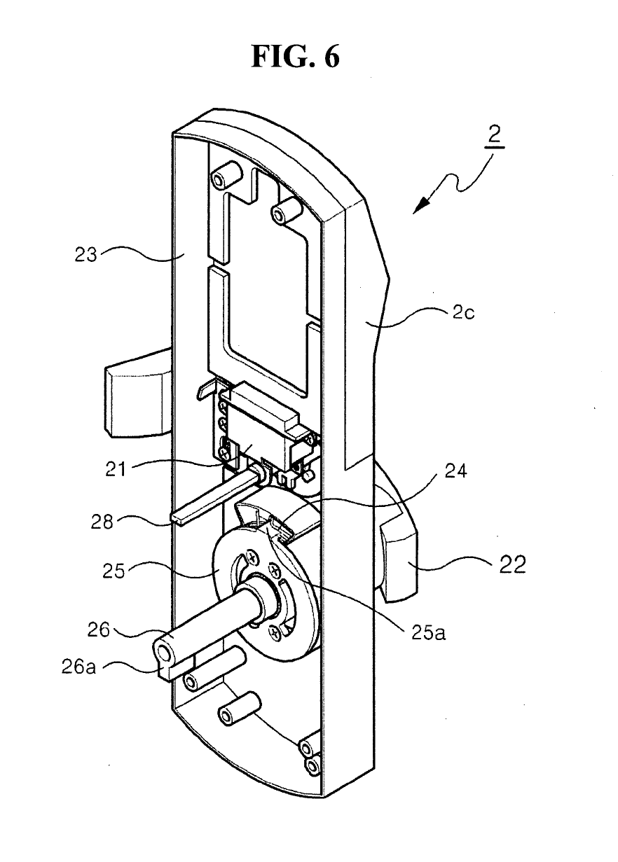

If the key revolving body 130 is revolved as described above, the plunger 28 as shown in FIG. 6 is revolved, and then the rotation lever 141 of the mortise lock 4 is revolved. Therefore, when the transfer arm 141b is revolved under the condition of FIG. 12a, as shown in FIG. 12b, the dead bolt 42 may be extruded outwards from the inside of the mortise lock 4 via the dead bolt drive plate 142.

Finally, if the handle grip 32 is revolved upwards as shown in FIG. 12b, the latch bolt 41 is retreated inwards the mortise lock 4, and the dead bolt 42 remains extruded outwards the mortise lock 4.

That is to say, if the internal electronic parts, particularly a motor, is damaged or there is no power source for driving a motor, a door may be locked manually by lifting a handle grip 32 upwards without exchanging a dry battery or the motor. Accordingly, ones may be out without anxiety.

However, if a force applied to the handle grip 32 is removed when the handle grip 32 is pushed upwards as shown in FIG. 12b, the free ends of the elastic member 34, which are wide opened as shown in FIG. 7, are contracted, and therefore the first projection 35a of the disk 35 is returned to the initial state by means of a restoring force of the free end of the elastic member 34. In this case, the disk 35 is returned to the normal state since it is revolved counterclockwise, as shown in FIG. 12c.

If the disk 35 is returned to the normal state as described above, the lift plate 36 moves down by means of a dead weight. At this time, an interfacial portion 36b of the lift plate 36 does not further move down since it hangs on a stopper 33d formed in the housing 33.

Accordingly, if the disk 35 is returned to the normal state by means of the elastic member 34, the protruded plate 36a of the lift plate 36 moves down, and therefore the drive plate 46 of the mortise lock 4 is resiliently operated by means of a restoring force of the elastic member 45, and then the latch bolt 41 is extruded inwards the mortise lock 4, thereby to sustain the state of FIG. 12c.

Meanwhile, if the disk 35 is revolved counterclockwise, the rotary moving body 37 is also revolved together with the disk 35, and therefore a horizontal wing 37b-1 of the rotary moving body 37, which pushed the protruded plate 39a of the revolving body driving slider 39 upwards, is returned to the normal state. In this case, the slider 39 is resiliently returned to the normal state as shown in FIG. 12c since the extended elastic member 139 is contracted.

The condition of FIG. 12c shows that a door is wound (locked). Here, the dead bolt 42 may be unlocked only if the input numbers are identical to a password set inside a door lock, or if a fingerprint recognition system with a fingerprint recognition device is operated when the password is inputted by manipulating various keypads installed inside a cover 3c of the outer unit 3.

3. Description of Operation of Dead Bolt for Emergency Release of Door:

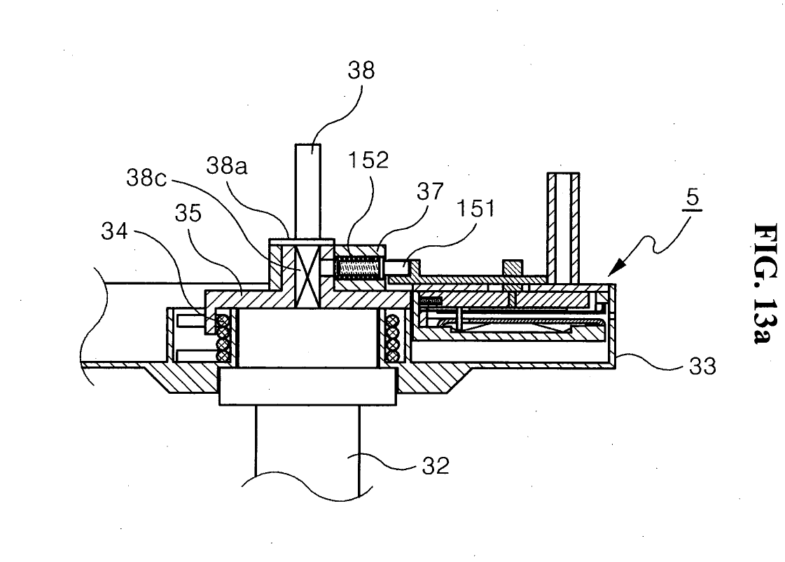

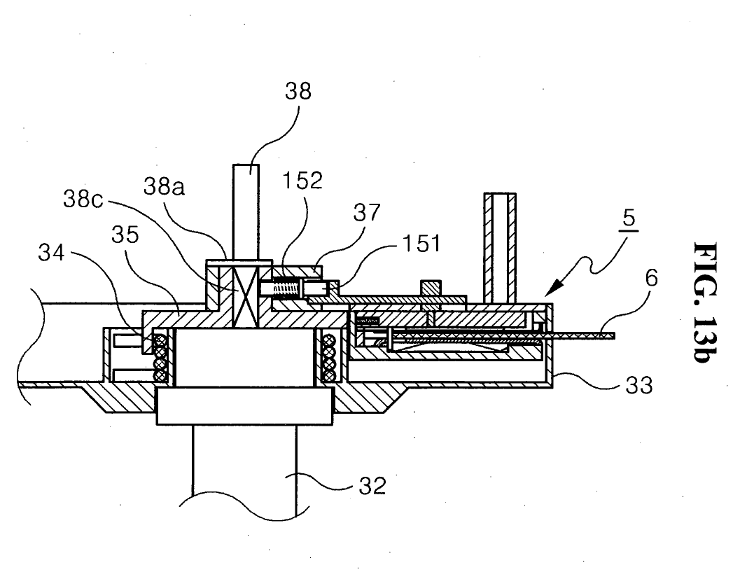

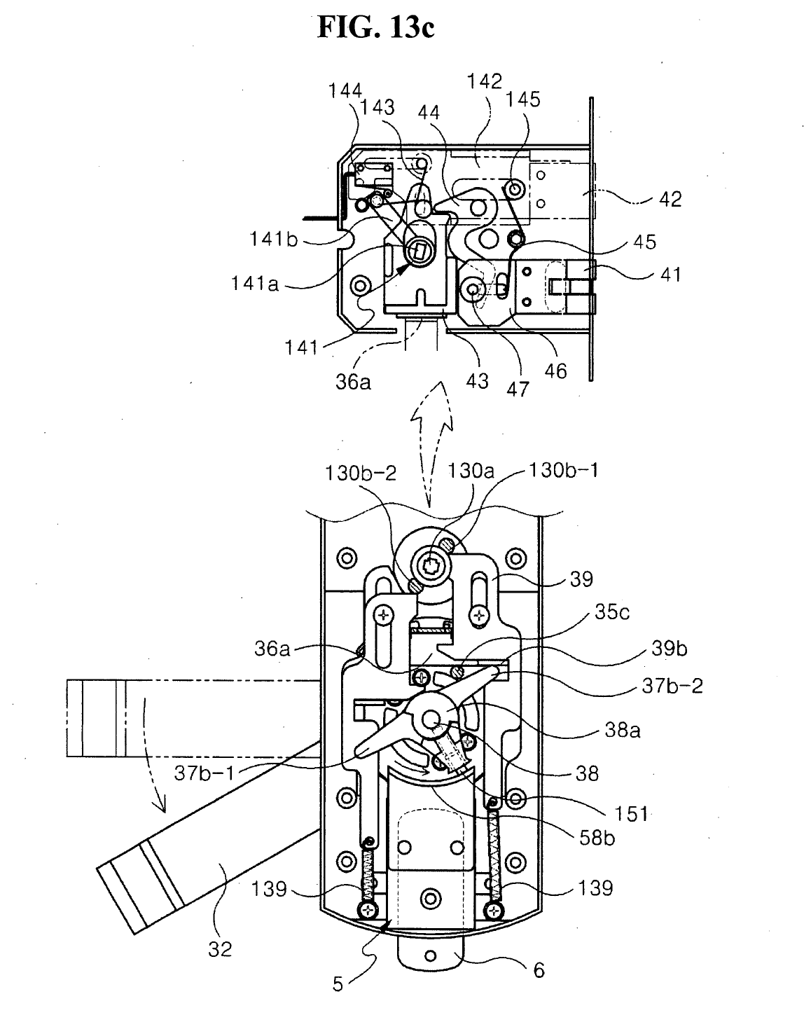

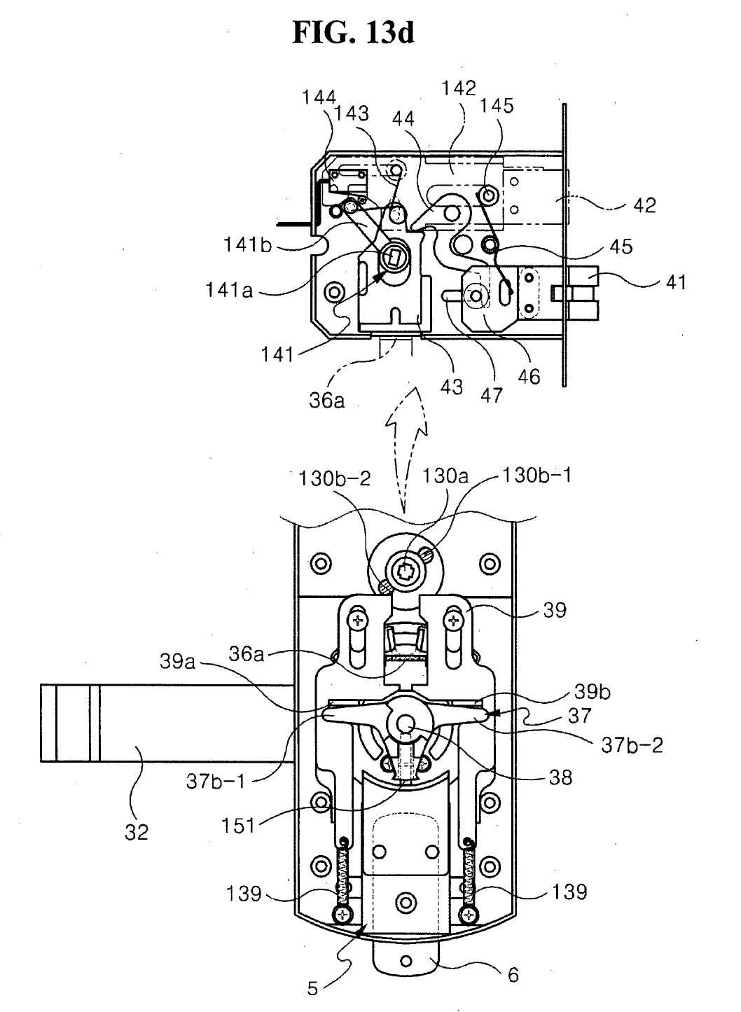

Although the handle grip 32 of the outer unit 3 moves down under the condition of FIG. 12c, a shoulder portion 38b of the plunger 38 is not associated with a projection 37f of the rotary moving body 37, as shown in FIG. 12d. Therefore, on the lift plate 36 ascends, but the rotary moving body 37 is not revolved at all. Accordingly, the dead bolt 42 may not be unlocked from the outside of the door until the plunger 38 and the rotary moving body 37 are artificially integrated with each other (see FIG. 13a).

If a door is locked as shown in FIG. 12c when an electric current of a dry battery installed in the inner unit 2 flows weakly, it is impossible to unlock the dead bolt 42 as described above even if a handle grip 32 of the outer unit 3 is forcibly operated.

Accordingly, the door locking apparatus of the present invention includes an emergency release assembly 5 being able to unlock the dead bolt 42 from the outside of the door 1 by artificially integrating the rotary moving body 37 with the plunger 38 as shown in FIG. 13b.

As shown in FIG. 12e, if the emergency card 6 is inserted into the emergency release assembly 5, the slider 58 moves toward the rotary moving body 37. At this time, the rotary moving body 37 and the plunger 38 are revolved together when revolving the disk 35 since the locking pin 151 is passed through the inside of the rotary moving body 37, and therefore an end of the slider 39 forcibly revolves a projection 130b-1 of the key revolving body 130 since a horizontal wing 37b-2 of the rotary moving body 37 pushes a protruded plate 39b of the slider 39, thereby to sustain the state as shown in FIG. 13c.

That is to say, if the handle grip 32 is revolved as shown in FIG. 13c when the emergency card 6 is inserted into the emergency release assembly 5 as shown in FIG. 12e, the key revolving body 130 is revolved since the rotary moving body 37 pushes the slider 39 upwards. If the key revolving body 130 is revolved as described above, the plunger 28 as shown in FIG. 6 is revolved, and then the rotation lever 141 of the mortise lock 4 is revolved, and therefore the transfer arm 141b is associated from the condition of FIG. 12e, as shown in FIG. 13c. At this time, the dead bolt 42 may be contracted to unlock a door from the outside of the mortise lock 4 via the dead bolt drive plate 142.

And, if a force applied to the handle grip 32 is removed as shown in FIG. 13c, the slider 39 may be returned to the normal state by means of a restoring force of the elastic member 139, as shown in FIG. 13c.

The emergency release systems of the emergency release assembly 5 and the emergency card 6 will be described in more detail, as follows.

That is to say, referring to an operating system in which the emergency card 6 is inserted into the emergency release assembly 5, as shown in FIG. 12e, to allow the slider 58 to operate a locking pin 151, the emergency card 6 is inserted between upper/lower plates 52a,52b, as shown in FIG. 9. At this time, the emergency card 6 is easily inserted by means of a repulsion against an impact (N/S) of a magnet encoded in the emergency card 6 and an impact of a permanent magnet 56 installed inside a first slider 55. Here, an encoding technique for the magnet repulsion between the permanent magnet 56 and the emergency card 6 is not described herein since the encoding technique has been widely known in the art.

Accordingly, only if an encoding for the emergency card 6 accords with the number and the impact of magnets inserted into the first slider 55 of the emergency release assembly 5, the emergency card 6 is passed between an upper plate 52a and a lower plate 52b, and then a front end of the emergency card 6 pushes a front end 55c extruding downwards the first slider 55.

If the first slider 55 moves forwards as described above, a second slider 58 also moves forwards, wherein the second slider 58 is fixed in a hole 55d of the first slider 55 using a locking pin 58a. At this time, the pushing stick 58b pushes a locking pin 151 as shown in FIG. 12e, and therefore a pushing stick 58b of the second slider 58 is passed between the rotary moving body 37 and the disk 35 so that it can be associated with a rectangular surface 38c of the plunger 38, as shown in FIG. 13b.

Accordingly, when the plunger 38 is revolved integrally with the disk 35 and the rotary moving body 37, the dead bolt 42 may be unlocked, as shown in FIG. 13c.

Accordingly, when a dry battery installed inside the door locking apparatus is nearly dead, or when there are defects in internal control circuits and the like, the door 1 may be opened by unlocking the dead bolt 42 from the outside of the door if the emergency card 6 is inserted into the emergency release assembly 5 and the handle grip 32 is then revolved as shown in FIG. 13c although the dead bolt 42 remains locked.

Meanwhile, because a projected portion 26a of the rotary moving body driving pin 26 in the inner unit 2 installed inside the door 1 is coupled with a reception groove 37a of the rotary moving body 37 in the outer unit 3, the handle grip 22 may be freely revolved clockwise or counterclockwise, and therefore the latch bolt 41 and the dead bolt 42 of the mortise lock 4 may be locked and unlocked, thereby to open and close the door 1.

Accordingly, the door locking apparatus of the present invention may by useful to ensure safety in opening the door regardless of the components burned or melted in the emergency such as a fire since the door is not opened by the electromotion but mechanically opened in a one-touch system by means of an operation of a lever along with the latch bolt and the dead bolt while one leaves the room.

Also, the door locking apparatus of the present invention may by useful to ensure safety in opening the door by employing a mechanical connection system regardless of automatically opening the door with a barium ferrite emergency card, other than a key, into which a magnetic data is inputted, if a dry battery is dead, or if an electronic function the locking apparatus is out of order due to the defects in the circuits when one enters the room.

The description proposed herein is just a preferable example for the purpose of illustrations only, not intended to limit the scope of the invention, so it should be understood that other equivalents and modifications could be made thereto without departing from the spirit and scope of the invention as apparent to those skilled in the art. Therefore, it should be understood that the present invention might be not defined within the scope of which is described in detailed description but within the scope of which is defined in the claims and their equivalents.

As described above, the door lock apparatus according to the present invention has advantages, as follows. That is to say,

1. Manual Operation Compatible with Electromotion System;

The door is automatically opened by means of the password, the card and the fingerprint, and automatically locked when the door is closed, but the door can be manually closed by revolving the handle grip 32 of the outer unit 3 upwards under the worst circumstance such as a hitch of the door locking apparatus.

2. Panic Open Exit in Leaving Room;

The door can be safely opened regardless of the components burned or melted in the emergency such as a fire since the door is not opened by the electromotion but mechanically opened in a one-touch system by means of an operation of a lever along with the latch bolt and the dead bolt while one leaves the room.

3. Emergency Open Entry;

The door can be safely opened by employing a mechanical connection system regardless of automatically opening the door with a barium ferrite emergency card, other than a key, into which a magnetic data is inputted, if a dry battery is dead, or if an electronic function the locking apparatus is out of order due to the defects in the circuits when one enters the room.

4. Configuration of Metal Structures (Vandal Proop);

Nearly all components except for an insulator are manufactured with strong metal structures that are preventive to a fire and external damages, and particularly the inner unit and the outer unit can have high strength and purity of a natural zinc surface appearance by using a zinc die casting material and process.

5. Easy Operation;

The door locking apparatus of the present invention can be nearly all operated in a one-touch system, and therefore the door can be automatically opened by automatically reading a fingerprint when one touches a handle grip, and also automatically opened by automatically reading a RF tag when one touches a grip while putting on a ring-shaped tag. Also, a fingerprint or a card can be simply inputted from the outside of the door by employing a Command card having a programming function.

6. RF Card System Compatible with Traffic Card (Mifare Contactless Smart Card);

The present invention is characterized in that cards, into which a traffic card or a bank card with a traffic card function is inputted, may be used, and one of a basically provided small emergency card, a sticker-type electronic tag, and a key ring-type electronic tag may be selected and used conveniently.

Although the present invention has been described referring to the accompanying drawings, the present invention is not particularly limited thereto, so it is understood that various changes and modifications may be made in the spirit and scope of the present invention.

For example, the present invention may be applied to a door lock apparatus with a password-entering system, a mechanical door lock apparatus, a door lock apparatus using a card reader, or a door lock apparatus with a fingerprint recognition system.

What is claimed is:

1. A door locking apparatus having an inner unit having a handle grip and installed in one side of a door, and an outer unit installed in the other side of the door corresponding to the inner unit and having a handle grip, the door locking apparatus comprising:
a mortise lock having a dead bolt extruded and contracted by a driving force of a motor installed in the inner unit in order to lock/unlock a door, and a door locking/unlocking latch bolt operated by the handle grips, of the inner and outer units;
a latch bolt driving means for operating the latch bolt;
a dead bolt driving means for operating the dead bolt;
an emergency release assembly installed inside the outer unit and engaged with the handle grip of the outer unit in order to unlock the locked dead bolt when it is turned off by means of the motor; and
an emergency card inserted into the emergency release assembly to unlock the dead bolt.

2. The door locking apparatus according to claim 1, wherein the mortise lock 4 opens/closes the latch bolt, wherein the mortise lock comprises:
a latch driving slider having a groove slid when the handle grips of the inner and outer units is independently revolved and receiving a rotation lever, and a shoulder portion for driving a link member;
a link member engaged with the latch driving slider to operate the latch bolt so as to open/close a door;
an elastic member for supplying elasticity to the latch driving slider when operated by the link member;
a drive plate connected with the latch bolt; and
a pin fixed to the drive plate and associated with one end of the link member.

3. The door locking apparatus according to claim 1, wherein the mortise lock 4 further comprises:
a rotation lever having a hole into which a pivot of a plunger is inserted so that it is revolved together when revolving the motor installed in the inner unit, and a dead bolt transfer arm;
a dead bolt drive plate for fixing a dead bolt in its one end and having guide slots and a reception notch unit receiving the dead bolt transfer arm; and
an elastic member for resiliently driving the dead bolt drive plate when operating the transfer arm.

4. The door locking apparatus according to claim 1, wherein the outer unit comprises a housing having the rotation driver of the handle grip inserted thereinto and including a convex groove and a convex groove formed therein, wherein the convex groove defines a swivel angle of the handle grip, and the convex groove for inserting a spherical elastic member gives elasticity to the handle grip and being integrally formed therein.

5. The door locking apparatus according to claim 1, wherein the inner unit comprises a housing having the rotation driver of the handle grip inserted thereinto and including a convex groove, a convex groove and a fixed clamp plate, wherein the convex groove defines a swivel angle of the handle grip, the convex groove for inserting a spherical elastic member gives elasticity to the handle grip, and the fixed clamp plate having two projections formed therein, the projections defining a swivel angle of the plunger.

6. The door locking apparatus according to claim 1, wherein the latch bolt driving means comprises;
a disk having a first projection, two second projections and a rectangular through hole formed in its central protrusion and including a pinhole into which the locking pin is inserted, wherein the first projection is fixed in the rotation driver of the outer unit and associated between both ends of the elastic member to determine a swivel angle of the handle grip, the second projections pushing a lift plate upwards when revolving the handle grip; and
a lift plate including a protruded plate being able to be ascended/descended in a vertical direction by means of the second projections when revolving the disk in order to push a slider of the mortise lock.

7. The door locking apparatus according to claim 6, wherein the lift plate 36 is returned to the normal condition due to a load of the lift plate itself if it is pushed upwards by means of the second projection when revolving the disk, and then returned to the normal condition when counter-revolving the disk.

8. The door locking apparatus according to claim 6, wherein the dead bolt driving means comprises:
a rotary moving body coupled to a central protrusion of the disk, prevented from being revolved when the latch bolt driving means is operated by the handle grip of the outer unit and revolved at a predetermined angle in a left or right direction when the dead bolt is locked and unlocked, and including horizontal wings and a vertical convex groove to which the projected portion of the revolving body driving pin of the inner unit is coupled;
a plunger including a pivot having a shoulder portion and a rectangular section for revolving the rotary moving body or preventing the rotary moving body from being revolved if it is inserted into the rectangular through hole of the disk to revolve the handle grip;
a key revolving body having a groove and two projections formed therein, wherein the pivot of the plunger revolved by the motor of the inner unit when opening/closing the door is inserted into the groove through the hole of the mortise lock;
a pair of revolving body driving sliders having protruded plates associated respectively with the horizontal wings of the rotary moving body when locking and unlocking the dead bolt; and
a pair of elastic members for giving elasticity to the revolving body driving slider.

9. The door locking apparatus according to claim 1, wherein the dead bolt driving means performs a lock function since the dead bolt is locked if the handle grip of the outer unit is revolved upwards when the driving motor and the electronic components are out of order.

10. The door locking apparatus according to claim 5, wherein the inner unit comprises;
a disk having a projection and a rectangular hole formed in its central protrusion, wherein the projection is fixed in the rotation driver of the handle grip and associated between both ends of the elastic member to determine a swivel angle of the handle grip;
a rotary moving body driving pin having a projected portion and a rectangular projection, wherein the projected portion is revolved together when revolving the disk and inserted into the vertical convex groove formed in the rotary moving body of the outer unit to operate the latch bolt and the dead bolt by operating the lift plate and the revolving body driving slider of the outer unit when revolving the handle grip, and the rectangular projection is inserted into the rectangular hole of the disk; and
a plunger for revolving a pair of gears and a rotation lever of the mortise lock together to lock and unlock the dead bolt, wherein the gears are revolved by receiving a driving force of the motor, and the rotation lever is fixed in the gear to revolve and counter-revolve the dead bolt at a predetermined angle.

11. The door locking apparatus according to claim 5, wherein the plunger includes a stopper for defining a swivel angle of the plunger in a space between the two projections of the fixed clamp plate.

12. The door locking apparatus according to claim 1, wherein the emergency release assembly comprises:
a body including an opening for inserting an emergency card and a reception groove and fixed in the housing of the outer unit;
upper/lower plates for easily inserting the emergency card inserted into the opening of the body;
an elastic plate for resiliently supporting the upper/lower plates against the body;
a magnet-fixed clamp plate installed onto the upper plates and having through holes for receiving a plurality of cylindrical magnets, formed therein;
a first slider having a plurality of cylindrical convex grooves and a spring reception groove formed therein and being able to be slid by the emergency card, the cylindrical convex grooves corresponding to the through holes of the magnet-fixed clamp plate;
a plurality of magnets arranged between the magnet-fixed clamp plate and the first slider to permit the first slider to move only when a valid emergency card is inserted since it is operated by means of an impact and a repulsion of the emergency card when inserting the emergency card;
a cover being able to be fixed in the body to receive the upper/lower plates, the elastic plate, the magnet-fixed clamp plate, the first slider and the magnets into the reception groove of the body, and simultaneously fixed in the housing and having an opening;
a second slider fixed in the first slider through the opening of the cover and slid to give a bias force so that the rotary moving body and the plunger are revolved integrally; and
a rod and a spring being able to be inserted into the reception groove to give elasticity to the first slider.

13. The door locking apparatus according to claim 12, wherein a through hole for receiving a locking pin and a spring is formed in the rotary moving body of the outer unit; and
wherein the rotary moving body is revolved together with the plunger when the second slider moves forwards, and the rotary moving body allows the plunger of the inner unit to revolve the rotation lever of the mortise lock by operating the revolving body driving slider to revolve the key revolving body, thereby to manually unlock the dead bolt.

14. The door locking apparatus according to claim 1, wherein the door locking apparatus has one of the password recognition means using a keypad, the fingerprint recognition means using a fingerprint recognition device, and the card recognition means operated by the card reader.

15. The door locking apparatus according to claim 1, wherein the door locking apparatus has the password recognition means using a keypad and the fingerprint recognition means using a fingerprint recognition device at the same time.

16. The door locking apparatus according to claim 1, wherein the door locking apparatus has the password recognition means using a keypad and the card recognition means using a card reader at the same time.

17. The door locking apparatus according to claim 1, wherein the door locking apparatus has the fingerprint recognition means using a fingerprint recognition device and the card recognition means operated by the card reader at the same time.

18. The door locking apparatus according to claim 1, wherein the door locking apparatus has the password recognition means using a keypad, the fingerprint recognition means using a fingerprint recognition device, and the card recognition means operated by the card reader at the same time.
